(19) United States
(12) Patent Application Publication
(10) Pub. No.: US 2017/0212868 A1
(43) Pub. Date: Jul. 27, 2017

(54) METHOD FOR COMPUTING CONFORMAL PARAMETERIZATION

(71) Applicant: SHING-TUNG YAU, CAMBRIDGE, MA (US)

(72) Inventors: WEI-QIANG HUANG, KAOHSIUNG CITY (TW); XIANFENG DAVID GU, PLAINVIEW, NY (US); WEN-WEI LIN, TAIPEI CITY (TW); SHING-TUNG YAU, CAMBRIDGE, MA (US)

(21) Appl. No.: 15/006,674

(22) Filed: Jan. 26, 2016

(51) Int. Cl. G06F 17/16

(52) U.S. Cl. CPC G06F 17/16

(57) ABSTRACT

A method for computing conformal parameterizations is revealed. First discrete conformal maps are reviewed for computing a generalized eigenvalue problem (GEP) arising from spectral conformal parameterization. Then nonequivalence deflation and null-space free compression techniques are applied to transform the GEP to a small-scaled compressed and deflated standard eigenvalue problem (CDSEP). Lastly a skew-Hamiltonian isotropic Lanczos algorithm (SHILA) is used to solve the CDSEP. Numerical experiments and comparisons are presented to show that the present method compute the conformal parameterization accurately and efficiently.

### BACKGROUND OF THE INVENTION

Field of the Invention

The present invention relates to a computing method, especially to a method for computing conformal parameterizations.

Descriptions of Related Art

In the past decades, numerous methods for computing conformal mesh paramterizations have been developed due to the vast applications in the field of geometry processing. Spectral conformal parameterization (SCP) is one of these methods used to compute a quality conformal parameterization based on the spectral techniques. SCP focuses on a generalized eigenvalue problem (GEP) L_{C}f=λBf whose eigenvector is corresponding to the smallest positive eigenvalue will provide a conformal parameterization. Based on the structures of matrix pair (L_{C}, B), it is found that this GEP can be transformed into a small-scaled compressed problem.

Matrix computation is a fundamental tool in digital geometry processing. Many interesting and challenging problems in computational geometry eventually are confronted with the difficulty of how to solve the corresponding problems within the context of matrix computation, such as linear systems, eigenvalue problems, optimization problems, and so on. Certainly, many excellent theoretical investigations, numerical algorithms about these subjects, and numerous well-developed libraries, such as LAPACK, ARPACK, PETSc, SPLEPc, etc., are capable of handling these problems. Nevertheless, the existing methods may still encounter some difficulties such as getting error or unwanted solutions, suffering from slow convergence, or even failing to converge. Therefore, based on the special structure of the targeting problem, it is still an important task for developing accurate, efficient and robust methods.

Mesh parameterization is an important and active subject in the research of digital geometry processing. Its goal is to construct a piecewise linear map between a triangulated 3D mesh surface and a 2D planar mesh. Once appropriate parameterizations are obtained, any complicated processing tasks on surfaces can be transformed into easier ones on the planar domain through the correspondences of geometric information between the surface mesh and the planar mesh. Mesh parameterizations almost introduce distortion in either angles or areas, and the main challenge for parameterization approaches is to minimize the resulting distortion in some sense as much as possible. Maps that minimize the angular distortion are called conformal maps and that preserve the area are called authalic maps. Excellent surveys on various kinds of mesh parameterization techniques can be found in advances in multiresolution for Geometric Modelling, by M. Floater and K. Hormann., Mesh parameterization methods and their applications by A. Sheffer, et. al, and Mesh parameterization: Theory and practice by K. Hormann, et. al, and the references therein. Many feasible conformal parameterization methods have been intensively studied and developed since several applications require angle-preserving parameterizations. Such applications include texture mapping, remeshing, compression, recognition, and morphing, to name just a few. According to the outputs of conformal parameterizations, most of them can be classified into one of the following categories: map category, differential l-form category, angle structure category, and metric category.

The discrete conformal paramterization (DCP) proposed by Desbrun et al. computes the conformal parameterization by minimizing the Dirichlet energy defined on triangle meshes subject to so-called natural boundary conditions. Through the least-squares approximation of the discrete Cauchy-Riemann equation, L'evy et al. introduced the approach of least squares conformal maps (LSCM) for conformal mesh parameterization. These two methods can achieve parameterizations with much lower angle distortion and. LSCM and DCP are theoretically equivalent. More recently, Mullen et al. presented a spectral approach, named spectral conformal parameterization (SCP), to reduce common artifacts of LSCM and DCP due to positional constraints or mesh sampling irregularity, and thereby achieve high-quality conformal parameterizations. SCP tends to compute the conformal parameterization via a constrained energy minimization problem which can be transformed into to a generalized eigenvalue problem L_{C}f=λBf with (L_{C}, B) being a symmetric positive semi-definite matrix pair. Therefore, to determine the minimizer of the constrained optimization problem, i.e., the desired result of the parameterization, is equivalent to find the smallest positive eigenvalue λ and the associated eigenvector f of (L_{C}, B).

For the computation of the generalized eigenvalue problem L_{C}f=λBf, Mullen et al. and, most recently, Alexa and Wardetzky individually proposed feasible numerical methods. The former considered an inverted modified eigenvalue problem instead of the original one; the latter reformulated the original problem as an equivalent small-scaled problem. However, these techniques do not take advantage of the matrix structures to improve the efficiency of numerical computations. In fact, it is found that, after a suitable permutation, L_{C} is indeed a symmetric positive semi-definite skew-Hamiltonian matrix and B is a low-rank positive semi-definite matrix. Thus through the particular matrix structures, efficient and robust methods for solving the generalized eigenvalue problem arising from the SCP can be found out.

### SUMMARY OF THE INVENTION

Therefore it is a primary object of the present invention to provide a method for computing conformal parameterizations by solving generalized eigenvalue problems.

In order to achieve the above object, a method for computing conformal parameterizations according to the present invention includes a plurality of steps. Firstly compute a generalized eigenvalue problem (GEP) L_{C}f=λBf whose eigenvectors are corresponding to the smallest positive eigenvalues for providing a conformal parameterizations. Then apply nonequivalence deflation and null-space free compression techniques to transform the GEP to a small-scaled compressed and deflated standard eigenvalue problem (CDSEP) with a symmetric positive semi-definite skew-Hamiltonian operator by inspecting a particular matrix structures of a pair (L_{C}, B). Lastly use a skew-Hamiltonian isotropic Lanczos algorithm (SHILA) for solving the CDSEP.

### BRIEF DESCRIPTION OF THE DRAWINGS

The patent or application file contains at least one drawing executed in color. Copies of this patent or patent application publication with color drawings will be provided by the Office upon request and payment of the necessary fee.

The structure and the technical means adopted by the present invention to achieve the above and other objects can be best understood by referring to the following detailed description of the preferred embodiments and the accompanying drawings, wherein:

FIG. 1 Residuals and B-orthogonality for SL_{CDSEP}, L_{CDSEP}, E_{MGEP} and SC_{RGEP} of an embodiment according to the present invention;

FIG. 2 shows the Beetle model of an embodiment according to the present invention;

FIG. 3 shows the Bimba model of an embodiment according to the present invention;

FIG. 4 shows the Bunny model of an embodiment according to the present invention;

FIG. 5 shows the Julius Caesar model of an embodiment according to the present invention;

FIG. 6 shows the Julius Camel model of an embodiment according to the present invention;

FIG. 7 shows the Chinese Lion model of an embodiment according to the present invention;

FIG. 8 shows the Dino model of an embodiment according to the present invention;

FIG. 9 shows the Fandisk model of an embodiment according to the present invention;

FIG. 10 shows the Foot model of an embodiment according to the present invention;

FIG. 11 shows the Gargoyle model of an embodiment according to the present invention;

FIG. 12 shows the Hand model of an embodiment according to the present invention;

FIG. 13 shows the Isis model of an embodiment according to the present invention;

FIG. 14 shows the Pipes model of an embodiment according to the present invention;

FIG. 15 shows the Max Planck model of an embodiment according to the present invention;

FIG. 16 shows the Saddle model of an embodiment according to the present invention;

FIG. 17 shows the Sophie model of an embodiment according to the present invention;

FIG. 18 shows the Susan model of an embodiment according to the present invention;

FIG. 19 shows the Nicolo da Uzzano model of an embodiment according to the present invention;

FIG. 20 shows the Vase Lion model of an embodiment according to the present invention.

### DETAILED DESCRIPTION OF THE PREFERRED EMBODIMENT

The present method is achieved by the following three techniques. (i) nonequivalence deflation: a deflation technique is used to transform the zero eigenvalues of a generalized eigenvalue problem into the infinite ones while preserving all the other eigenvalues and associated eigenvectors; (ii) null-space free compression: an approach of the model reduction to reduce a generalized eigenvalue problem to a small-scaled standard eigenvalue problem based on the low-rank property; (iii) SHILA algorithm: a novel skew-Hamiltonian Isotropic Lanczos Algorithm for solving standard skew-Hamiltonian eigenvalue problem that can precisely split the duplicate eigenvalues and improve the convergence rate efficiently. Thus the present method provides an efficient, accurate and robust engensolver for the SCP.

### NOTATIONS AND OVERVIEW

The following notations are frequently used throughout this paper. Other notations will be clearly defined whenever they are used.

nᵥ denotes the number of vertices; nᵢ denote the number of interior vertices as well as internal boundaries (if any) while n_{b} represents the number of (external) boundary vertices.
Upper case letters indicate matrices and bold face letters denote vectors.
In denotes the n×n identity matrix with the given size n.
eⱼ denotes the jth column of the identity matrix In with specified n.
1n denotes an n-vector whose elements are all 1.
In particular, 0 is used to denote zero vectors and matrices with appropriate size.
•^{T} is used to denote the transpose of vectors or matrices.

### 2 Discrete Conformal Maps

For a smooth map f:x→u, the Dirichlet energy ε_{D}(f) and the area of the image of f, A(f) are defined by

$${ɛ}_{D} ( f ) = \frac{1}{2} {\int }_{χ} {\vert ∇ f \vert}^{2} d σ , A ( f ) = {\int }_{χ} det ( {J}_{f} ) d σ ,$$

respectively, where J_{f} is the Jacobian matrix of f and dσ, is the area element of the surface. The conformal energy of f is the difference of ε_{D}(f) and A(f), defined by

ε_{C}(f)=ε_{D}(f)−A(f). (2.1)

Based on the relation ε_{D}(f)≧A(f) [32, 6], ε_{C}(f)≧0 with the equality only when f is a conformal map.

By the discretization approach, x and u are used to be triangular meshes in [symbol] ³ and [symbol] ², respectively. Let

$$f = [ \begin{matrix}u \\ v\end{matrix} ] = {[ {u}_{1} , … , {u}_{n} , {υ}_{1} , … , {υ}_{n} ]}^{T}$$

represent a piecewise-linear map from x to u. Then the discrete Dirichlet energy can be expressed as

$${E}_{D} ( f ) = \frac{1}{2} {\sum }_{{e}_{ij}} \frac{cos {θ}_{ij} + cot {θ}_{ji }}{2} [ {( {u}_{i } - {u}_{j} )}^{2} + {( {v}_{i} - {v}_{j} )}^{2} ] = \frac{1}{2} {f}^{T} {L}_{D} f , \qquad ( 2.2 )$$

where □ᵢⱼ and □ⱼᵢ are the two corner angles against to the edge eᵢⱼ connecting vertices i; j on x, and

$${L}_{D} = [ \begin{matrix}K & 0 \\ 0 & K\end{matrix} ] ∈ {}^{2 {n}_{v} \times 2 {n}_{v}} \qquad ( 2.3 )$$

is the discrete Laplacian matrix with

$${K}_{ij} = \{ \begin{matrix}- \frac{1}{2} ( cos {θ}_{ij} + cot {θ}_{ji} ) & if j ∈ N ( i ) , \\ {\sum }_{𝓁 ∈ N ( i )} {K}_{i 𝓁} & if j = i , \\ 0 & otherwise ,\end{matrix}$$

in which N(i) denotes the set of all neighboring vertices of vertex i. Moreover, it is found that K1 nᵥ=0. On the other hand, the area of the parameterization can be expressed as

$$A ( f ) = \frac{1}{2} {\sum }_{{c}_{ij} ∈ \partial 𝒰} ( {u}_{i} {v}_{j} - {u}_{j} {v}_{i} ) = \frac{1}{2} {f}^{T} Af , \qquad ( 2.4 )$$

where ∂u is the set of boundary edges of u, and

$$A = [ \begin{matrix}0 & - S \\ S & 0\end{matrix} ] \qquad ( 2.5 )$$

is a 2nᵥ×2nᵥ symmetric matrix with S^{T}=−S and S1 nᵥ=0. Specifically, if (uᵢ; vᵢ) and (uⱼ; vⱼ) are the endpoints of a boundary edge on u, then

$${u}_{i} {v}_{j} - {u}_{j} {v}_{i} = [ \begin{matrix}{u}_{i} & {u}_{j} \vert {v}_{i} & {v}_{j}\end{matrix} ] [ \begin{matrix}\begin{matrix}0 & 0 \\ 0 & 0\end{matrix} & \begin{matrix}0 & \frac{1}{2} \\ - \frac{1}{2} & 0\end{matrix} \\ \begin{matrix}0 & - \frac{1}{2} \\ \frac{1}{2} & 0\end{matrix} & \begin{matrix}0 & 0 \\ 0 & 0\end{matrix}\end{matrix} ] [ \begin{matrix}{u}_{i} \\ \frac{{u}_{j}}{{v}_{i}} \\ {v}_{j}\end{matrix} ]$$

and the matrix A in (2.5) is the assembly of the above 2×2 elementary block matrices. As a result of (2.1)-(2.5), the discrete conformal energy can then be represented in a quadratic form

$$\begin{matrix}{E}_{C} ( f ) = \frac{1}{2} {f}^{T} {L}_{C} f , \\ where & ( 2.6 ) \\ {L}_{C} = {L}_{D} - A = [ \begin{matrix}K & S \\ - S & K\end{matrix} ] & ( 2.7 )\end{matrix}$$

with K and S being symmetric positive semi-definite and skew-symmetric, respectively. In Quality surface meshing using discrete parameterizations by E. Marchandise et al, Marchandise et al. derived the same matrix structure and property based on the finite element method for the minimization problem of the quadratic energy E_{C} in (2.6).

### Remark 1.

The matrix L_{C} satisfies the following properties.

(i) L_{C} is symmetric and skew-Hamiltonian, i.e., L_{C}=L_{C} and (L_{C}Jnᵥ)^{T}=−(L_{C}Jnᵥ) with

$${J}_{{n}_{v}} = [ \begin{matrix}0 & {I}_{{n}_{v}} \\ - {I}_{{n}_{v}} & 0\end{matrix} ] . \qquad ( 2.8 )$$

There is a symplectic orthogonal U [symbol] ^{2nv×2nv} with U^{T} Jnᵥ U=J and U^{T}U=I₂ₙᵥ satisfying

$${U}^{T} {L}_{C} U = [ \begin{matrix}Λ & 0 \\ 0 & Λ\end{matrix} ] ,$$

where Λ is a nᵥ×nᵥ diagonal matrix. Since L_{C} is additionally, at least in theory, positive semi-definite, the above equality implies that the eigenvalues of L_{C} are nonnegative and double.

### (ii) Set

$${2}_{} = [ \begin{matrix}{1}_{{n}_{v}} & 0 \\ 0 & {1}_{{n}_{v}}\end{matrix} ] ∈ {2 {n}_{v} \times 2}^{} , \qquad ( 2.9 )$$

where 1nᵥ be an nᵥ-vector as defined in Section previously. Thus the following is obtained

L_{C} [symbol] ₂=0 (2.10)

as Klnᵥ=0=S1nᵥ. Moreover, it is concluded that 0 is a semi-simple eigenvalue of L_{C} with multiplicity 2.

### The Spectral Conformal Parameterization

The connection between the minimization problem of the conformal energy (2.6) and the associated generalized eigenvalue problem in SCP is briefly reviewed.

### Minimization of Conformal Energy

The piecewise-linear mapping f is called a discrete conformal parameterization if it minimize the conformal energy E_{C} (f) in (2.6). Lé-vy et al. and Desbrun et al. independently proposed LSCM and DCP, which are theoretically equivalent, to achieve such an energy minimization problem. Through pinning down two vertices in the parameter region to eliminate the inherent rank-deficiency, the non-trivial parameterization result (f≠constant) of LSCM/DCP can be uniquely determined by solving the linear system E_{C} f=0. The choice of which vertices to be fixed, however, significantly affects the quality of the conformal parameterization.

To remedy this problem, Mullen et al. suggested a spectral approach based on the so-called (generalized) Fiedler vector to avoid the explicit constraint on specific vertices. To this end, Mullen et al. focused on the following constrained minimization problem:

$${min}_{f} {f}^{T} {L}_{C} f subject to {f}^{T} B {2}_{} = 0 , {f}^{T} Bf = 1 , \qquad ( 3.1 )$$

where E_{C} and [symbol] are defined as in (2.6) and (2.9), respectively, and B is a degenerate and diagonal binary matrix whose nonzero elements correspond to the (external) boundary vertices. Note that B can be expressed as the block-diagonal form

$$B = [ \begin{matrix}D & 0 \\ 0 & D\end{matrix} ] ∈ {ℝ}^{2 {n}_{v} \times 2 {n}_{v}} , \qquad ( 3.2 )$$

where D is an nᵥ×nᵥ diagonal binary matrix with 1 at the diagonal entries corresponding to the boundary vertices (not including any of internal boundaries). The constraints in (3.1) indicate that the barycenter of the boundary components must be at zero (f^{T}B [symbol] ₂=0), and the moment of inertia on the boundary must be unit (f^{T}Bf=1). The following lemma shows that, to solve the optimization problem (3.1) is equivalent to find the eigenvector of the generalized eigenvalue problem (GEP)

L_{C}f=λBf (3.3)

corresponding to the smallest positive eigenvalue.

### Lemma 1.

A vector f_{*} is an optimizer of the constrained energy minimization problem (3.1) if and only if f_{*} is the eigenvector of the GEP (3.3) corresponding to the smallest positive eigenvalue with f_{*}^{T}Bf_{*}⁻=1.

### Proof.

Consider the Lagrange function

C(f,μ,λ)=f^{T}L_{C}f−μ(f^{T}B [symbol] ₂)−λ(f^{T}Bf−1)

with Lagrange multipliers μ and λ. Then the solution f satisfies

$$\begin{matrix}\frac{\partial ℒ}{\partial f} = 2 {L}_{C} f - μ B {2}_{} - 2 λ Bf = 0 , & ( 3.4 a ) \\ \frac{\partial ℒ}{\partial μ} = {f}^{T} B {2}_{} = 0 , & ( 3.4 b ) \\ \frac{\partial ℒ}{\partial λ} = {f}^{T} Bf = 1. & ( 3.4 c )\end{matrix}$$

Premultiplying (3.4a) by [symbol] ₂^{T} the following the obtained

μ(n_{b}I₂)=2(L_{C} [symbol] ₂)^{T}f−2λ(f^{T}B [symbol] ₂)^{T}=0, (3.5)

where the last equality holds because of (2.10) and (3.4b). From (3.5), μ=0. As a result, (3.4a) can be reduced to the GEP (3.3).

Conversely, if f_{*} is the eigenvector corresponding to the smallest positive eigenvalue λ of the GEP (3.3) with the normalizing requirement f_{*}^{T}=Bf_{*}=1. Then, by (2.10), it is seen that

0=(L_{C} [symbol] ₂)^{T}f_{*}= [symbol] ₂^{T}(L_{C}f_{*})= [symbol] ₂^{T}(λBf_{*}), (3.6)

which implies that f_{*}^{T}B [symbol] ₂=0. So, f_{*} satisfies the requirements of constraints in (3.1). Furthermore, for any vector g satisfying g^{T}B [symbol] ₂=0 and g^{T}Bg=1, the following is obtained:

$${g}^{T} {L}_{c} g \geq {min}_{f} \{ {f}^{T} {L}_{C} f \text{:} {f}^{T} B {2}_{} = 0 , {f}^{T} Bf = 1 \} = λ = {f}_{s}^{T} {L}_{C} {f}_{s} .$$

Thus, f_{*} solves the constrained minimization problem (3.1).

In other words, the solution to (3.3) with the smallest positive eigenvalue determines the entire coordinates of the spectral conformal parameterization, named by Mullen et al.

### Previous Numerical Methods

To treat the GEP (3.3), Mullen et al. considered the modified GEP:

$$[ B - \frac{1}{{n}_{b}} ( B {2}_{} ) {( {2}_{} )}^{T} ] f = \frac{1}{λ} {L}_{C} f . \qquad ( 3.7 )$$

By taking

$$f = [ \begin{matrix}{1}_{{n}_{v}} \\ 0\end{matrix} ] or f = [ \begin{matrix}0 \\ {1}_{{n}_{v}}\end{matrix} ] ,$$

it is seen that both sides of (3.7) are equal to zero vectors which means that (3.7) is a singular GEP. Thus the modified GEP (3.7) can be ill posed in the sense that an arbitrary small perturbation may cause a large change of the eigenvalues and the associated eigenvectors. It will be seen that although (B [symbol] ²)^{T}f is theoretically equivalent to zero, in practice, it still has a significant numerical error and can further affect the residual norm ∥L_{C}f−λBf∥₂.

Alexa and Wardetzky recently addressed the GEP (3.3) via an equivalent smaller eigenvalue problem that only contains the boundary vertices. By reordering the vertex indices, the GEP (3.3) can be rewritten as

$$[ \begin{matrix}{L}_{ii} & {L}_{ib} \\ {L}_{ib}^{T} & {L}_{bb}\end{matrix} ] [ \begin{matrix}{f}_{i} \\ {f}_{b}\end{matrix} ] = λ [ \begin{matrix}0 & 0 \\ 0 & {B}_{b }\end{matrix} ] [ \begin{matrix}{f}_{i} \\ {f}_{b}\end{matrix} ] , \qquad ( 3.8 )$$

where i and b refer as to inner and (external) boundary vertices, respectively,

$${f}_{i} = [ \begin{matrix}{u}_{i} \\ {v}_{i}\end{matrix} ] , ∈ {2 ni}^{} , {f}_{b} = [ \begin{matrix}{u}_{b} \\ {v}_{b}\end{matrix} ] ∈ {2 nb}^{}$$

and B_{b} is a 2n_{b}×2n_{b} diagonal matrix with 1's on the diagonal corresponding to the (external) boundary vertices. Under such a structure, Alexa and Wardetzky considered the Schur complement of Lii from (3.8), L_{bb}−L_{ib}^{T}Lᵢᵢ⁻¹L_{ib}ε [symbol] ^{2nb×2nb}. Thus, (3.8) can be reduced to a small-scaled GEP

(L_{bb}−L_{ib}^{T}Lᵢᵢ⁻¹L_{ib})f_{b}=λB_{b}f_{b}, (3.9)

and fᵢ as well as f_{b} satisfy the relationship

fᵢ=−Lᵢᵢ⁻¹L_{ib}f_{b}. (3.10)

Compared with Mullen et al. who directly cope with the GEP (3.3), Alexa and Wardetzky first handle the reduced GEP (3.9) to obtain f_{b} and then determine the parameterization coordinates of interior vertices fᵢ via the equation (3.10).

Yet this approach still has some drawbacks and difficulties. First of all, λ=0 remains a semisimple eigenvalue of the GEP (3.9) associated with the eigenvectors

$${f}_{b} = [ \begin{matrix}{1}_{{n}_{b}} \\ 0\end{matrix} ] and {f}_{b} = [ \begin{matrix}0 \\ {1}_{{n}_{b}}\end{matrix} ]$$

so its kernel still affects the convergence and increase the computational cost. Secondly, to deal with the reduced GEP (3.9), we may first face the problem of solving a linear system

LᵢᵢX=L_{ib}. (3.11)

Even though Lᵢᵢ is well-conditioned, it can be impractical or even impossible to solve the linear system ahead just in order to solve “one” desired eigenvector. Here, the main reason is that the number of right-hand sides amounts to the number of all boundary vertices which may be more than hundreds or thousands of points, in particular for large meshes. Last but not least, as opposed to solving the linear system (3.11) in advance, we may adopt the iterative method to solve (3.9). The computational cost is due to the problem of inner-outer iterations. Especially for the inner step, we need to solve a singular linear system with the coeffcient matrix L_{bb}−L_{ib}^{T}Lᵢᵢ⁻¹L_{ib}.

### Theoretical Frameworks

A clever compression skill together with a novel eigensolver for solving the smallest positive eigenvalue and associated eigenvector of the GEP (3.3) is proposed.

L_{C}f=λBf,

where L_{C} is symmetric positive semi-definite, skew-Hamiltonian as defined in (2.7) and B, given in (3.2), is symmetric positive semi-definite.

### Nonequivalence Deflations

The GEP (3.3) possesses the zero eigenvalue with algebraic multiplicity 2 and, in fact,

$$Ker ( {L}_{C} ) = span \{ [ \begin{matrix}{1}_{{n}_{v}} \\ 0\end{matrix} ] , [ \begin{matrix}0 \\ {1}_{{n}_{v}}\end{matrix} ] \} .$$

To find the eigenpairs associated with the smallest positive eigenvalue of the GEP (3.3) and, at the same time, to exclude undesired eigenpairs corresponding the zero eigenvalue, based on the idea in W.-W. Lin, Beiträge zur numerischen Behandlung des allgemeinen Eigenwertproblems Ax=lambdaBx, Bielefeld: 1985 and W.-W. Lin, On reducing infinite eigenvalues of regular pencils by a nonequivalence transformation, Lin. Alg. Appl., 78(0): 207-231, 1986, a nonequivalence deation technique is introduced to transform the zero eigenvalues of the GEP (3.3) into the infinite ones while preserving all the other eigenvalues of (3.3).
Observe that since

d=D1ₙ_{ᵥ}≠0, (4.1)

It is known that

$$B {2}_{} = [ \begin{matrix}d & 0 \\ 0 & d\end{matrix} ] \neq 0 ,$$

where D and [symbol] ₂ are defined in (3.2) and (2.9), respectively. The nonequivalence transformation of the matrix pair (L_{C}, B) is defined by

$$\begin{matrix}{\tilde{L}}_{C} ≡ {L}_{C} + ( \frac{1}{{n}_{b }} B {2}_{} ) {( B {2}_{} )}^{T} = [ \begin{matrix}\tilde{K} & S \\ - S & \tilde{K}\end{matrix} ] , \\ \tilde{K} = K = \frac{1}{{n}_{b}} {dd}^{T} , & ( 4.2 a ) \\ \tilde{B} ≡ B - ( \frac{1}{{n}_{b}} B {2}_{} ) {( B {2}_{} )}^{T} = [ \begin{matrix}\tilde{D} & 0 \\ 0 & \tilde{D}\end{matrix} ] , \\ \tilde{D} = D - \frac{1}{{n}_{b}} {dd}^{T} . & ( 4.2 b )\end{matrix}$$

Observe that

\tilde{L}_{C} [symbol] ₂=B [symbol] ₂≠0, (4.3)

and

\tilde{B} [symbol] ₂=0. (4.4)

This indicates that such a nonequivalence deation skill transforms the kernel matrix [symbol] ₂ of L (to be parts of the kernel of \tilde{B}. As a matter of fact, more about the spectral behavior is learned by this technique.

### Theorem 1.

Let (\tilde{L}_{C}, \tilde{B}) be the deflated pair as defined in (4.2). Then

(i) \tilde{L}_{C} is symmetric positive definite and skew-Hamiltonian.
(ii) \tilde{B} is symmetric positive semi-definite with 2(nᵢ+1)'s semisimple eigenvalues 0 and 2(n_{b}−1)'s semisimple eigenvalues 1.
(iii) The deflated GEP

\tilde{L}_{C}f=λ\tilde{B}f (4.5)

preserves all eigenpairs of the original GEP (3.3) expect the case that λ=0. Instead, two semisimple zero eigenvalues of (3.3) are transformed into two semisimple infinite eigenvalues of (4.5) associated with eigenvectors

$$[ \begin{matrix}{1}_{{n}_{v}} \\ 0\end{matrix} ] and [ \begin{matrix}0 \\ {1}_{{n}_{v}}\end{matrix} ] .$$

### Proof.

(i) Clearly, \tilde{L}_{C} is symmetric and positive definite directly from the facts that L_{C} as well as

$$\frac{1}{{n}_{b}} ( B {2}_{} ) {( B {2}_{} )}^{T}$$

are both symmetric positive semi-definite, and their individual Rayleigh quotient cannot vanish simultaneously as

Ker(L_{C})∩Ker((B [symbol] ₂)(B [symbol] ₂)^{T})=ø.

Let Jnᵥ be the matrix in (2.8). It is easy to verify that Jnᵥ B=B Jnᵥ and Jₙ_{ᵥ} [symbol] ₂ [symbol] ₂^{T}= [symbol] ₂ [symbol] ₂^{T}Jₙ_{ᵥ}. Therefore, noting that L_{C} is a skew-Hamiltonian matrix and Jₙ_{ᵥ}^{T}=−Jₙ_{ᵥ}, the following is obtained:

$${( {\tilde{L}}_{C} {J}_{{n}_{v}} )}^{T} = - {L}_{C} {J}_{{n}_{v}} - \frac{1}{{n}_{b}} ( B ) {( B )}^{T} {J}_{{n}_{v}} = - ( {\tilde{L}}_{C} {J}_{{n}_{v}} ) ,$$

i.e., \tilde{L}_{C} is also a skew-Hamiltonian matrix.
(ii) Since \tilde{B} is a block-diagonal matrix composed of the deflated matrix \tilde{D} as in (4.2b), from Lemma 3 described later, it is concluded that the dimension of the eigenspace associated with the eigenvalue 1 of \tilde{B} is 2(nᵢ+1) and the nullity of \tilde{B} is equal to 2(n_{b}−1).
(iii) By the same proof technique as used for (3.6), we first observe that if (θ, g) is an eigenpair of the GEP (3.3) with θ≠0 then, [symbol] ₂ and g are B-orthogonal, i.e., [symbol] ₂ B g=0. As a result, from (4.2a) and (4.2b), it is learned that

\tilde{L}_{C}g=L_{C}g=θBg=θ\tilde{B}g. (4.6)

In addition, (4.3) and (4.4) imply that

$$[ \begin{matrix}{1}_{{n}_{v}} \\ 0\end{matrix} ] and [ \begin{matrix}0 \\ {1}_{{n}_{v}}\end{matrix} ]$$

are eigenvectors of the deflated GEP (4.5) corresponding to the infinite eigenvalues.

It is well known that the iterative projection methods, such as the Lanczos method or the Arnoldi method, rapidly provide approximate eigenvalues with large magnitude. To compute the smallest positive eigenvalue(s) and the associated eigenvector(s) of the deflated GEP (4.5), now invert the \tilde{L}_{C} and straightforwardly apply the Lanczos method to the standard eigenvalue problem (SEP) of the form

$$( {\tilde{L}}_{C}^{- 1} \tilde{B} ) f = \frac{1}{λ} f . \qquad ( 4.7 )$$

However, to deal directly with the problem (4.7) does not make use of the special structures of the coefficient matrices that \tilde{L}_{C} is symmetric positive definite, skew-Hamiltonian and \tilde{B} is symmetric positive semi-definite with low-rank. In the subsequent subsections, first expound how to draw on the low-rank property of \tilde{B} to reduce the SEP (4.7) to a symmetric positive definite and skew-Hamiltonian eigenvalue problem which is of the small size 2(n_{b}−1). Then, a modified Lanczos algorithm is proposed to solve this reduced problem efficiently.

### Null-Space Free Compression

The matrix B is a diagonal matrix with rank 2nb and the subsequent rank-two update deflating procedure causes the rank of \tilde{B} to be deficient by two (see Theorem 1 and Lemma 3). Compared with the matrix size of \tilde{B}, 2nᵥ, the rank of \tilde{B}, 2(n_{b}1), seems “extremely small”. Therefore, a low-rank compression technique on \tilde{B} will have the benefits of reducing the matrix size, computational cost and memory storage for efficiently solving the SEP (4.7). As mentioned above in Theorem 1, 0 and 1 are the only two eigenvalues of \tilde{B} and, particularly, all of its eigenvectors can be formulated explicitly. Return to this point in the following description. Next the concept of low-rank compression to reduce the SEP (4.7) is explained.

### Lemma 2.

Let \tilde{B}₁ be a 2nᵥ×2(n_{b}−1) orthonormal matrix whose columns form an orthonormal basis of the eigenspace of \tilde{B} associated with the eigenvalue 1. Then \tilde{B}₁ can be represented in the form:

$${\tilde{B}}_{1} = [ \begin{matrix}{E}_{1} & 0 \\ 0 & {E}_{1}\end{matrix} ] , \qquad ( 4.8 )$$

where E₁ε [symbol] ⁿ^{ᵥ}^{×(n}^{_{b}}⁻¹⁾ satisfying E₁E₁^{T}=\tilde{D} with \tilde{D} as in (4.2b). Proof. By the Lemma 3 described later, it holds that rank (\tilde{D})=n_{b}−1. Let \tilde{D}=E₁E₁^{T} be a low-rank compression of \tilde{D}. Then, according to the matrix structure of \tilde{B} in (4.2b), it is seen that

$$\tilde{B} = [ \begin{matrix}\tilde{D} & 0 \\ 0 & \tilde{D}\end{matrix} ] = [ \begin{matrix}{E}_{1} {E}_{1}^{T} & 0 \\ 0 & {E}_{1} {E}_{1}^{T}\end{matrix} ] = [ \begin{matrix}{E}_{1} & 0 \\ 0 & {E}_{1}\end{matrix} ] [ \begin{matrix}{E}_{1}^{T} & 0 \\ 0 & {E}_{1}^{T}\end{matrix} ] ≡ {\tilde{B}}_{1} {\tilde{B}}_{1}^{T} .$$

### Theorem 2.

Under the assumption in the above Lemma 2, the SEP (4.7) can be reduced to the small-scaled, compressed and deflated SEP

$$( {\tilde{B}}_{1}^{T} {\tilde{L}}_{C}^{- 1} {\tilde{B}}_{1} ) {s}_{1} = \frac{1}{λ} {s}_{1} , \qquad ( 4.9 )$$

where \tilde{B}₁^{T}\tilde{L}_{C}⁻¹\tilde{B}₁ is symmetric positive definite and skew-Hamiltonian with size 2(n_{b}−1). From now on, CDSEP is used to indicate the equation (4.9).

### Proof.

Since \tilde{B} is symmetric positive semi-definite, by the assumption, first rewrite the matrix \tilde{B} to a condensed form

\tilde{B}=\tilde{B}₁\tilde{B}₁^{T}, (4.10)

where \tilde{B}₁ is a 2nᵥ×2(n_{b}−1) matrix as in (4.8). Moreover, if \tilde{B}₀ is a 2nᵥ×2(nᵢ+1) orthonormal matrix so that its columns span the kernel of \tilde{B}, then any 2nᵥ-vector f can be uniquely expressed as a linear combination of \tilde{B}₀ and e \tilde{B}₁, that is,

f=\tilde{B}₀s₀+\tilde{B}₁s₁ (41.1)

for some s₀ε [symbol] ²⁽ⁿ^{_{b}}⁺¹⁾ and s₁ε [symbol] ²⁽ⁿ^{_{b}}⁻¹⁾. Substituting equations (4.10) and (4.11) into (4.7), and premultipling the resulting equation by \tilde{B}₁^{\tilde{T}}, further reduce the SEP (4.7) to the small-scaled CDSEP (4.9) with size 2(n_{b}−1) because of the orthogonality \tilde{B}₁^{T}\tilde{B}₀=0.

It is obviously that \tilde{B}₁^{T}\tilde{L}_{C}⁻¹\tilde{B}₁ is symmetric. Since \tilde{B}₁ is orthonormal, by Theorem 1(i), it is concluded that \tilde{B}₁^{T}\tilde{L}_{C}^{-\check{1}}\tilde{B}¹ is positive definite. Now it is shown that \tilde{B}₁^{T}\tilde{\check{L}}_{C}⁻¹\tilde{B}₁ is skew-Hamiltonian. Let

$${J}_{𝓁} = [ \begin{matrix}\overline{0} & {I}_{𝓁} \\ - {I}_{𝓁} & 0\end{matrix} ]$$

with l=2(n_{b}−1). According to the block-diagonal-like form of \tilde{B}₁ in (4.8), it is seen that that \tilde{B}₁Jₗ=Jₙ_{ᵥ}\tilde{B}₁ where Jₙᵥ is the matrix defined in (2.8). Since Jₙ_{ᵥ}^{T}=−Jₙ_{ᵥ}=Jₙ_{ᵥ}⁻¹ and \tilde{L}_{C} is symmetric skew-Hamiltonian, it is easy to verify that \tilde{L}_{C}⁻¹Jₙ_{ᵥ}=Jₙ_{ᵥ}\tilde{L}_{C}⁻. Therefore, it is deduced that

\tilde{B}₁^{T}\tilde{L}_{C}⁻¹\tilde{B}₁Jₗ)^{T}=(Jₗ\tilde{B}₁^{T}\tilde{L}_{C}⁻¹\tilde{B}₁)^{T}=−\tilde{B}₁^{T}\tilde{L}_{C}⁻¹\tilde{B}₁Jₗ.

From (4.7)-(4.11), as soon as we obtain an eigenpair (λ⁻¹, s₁) of the CDSEP (4.9), the desired eigenvector f of the deflated GEP (4.5) (and hence of the original GEP (3.3)) can be obtained directly through the relation

f=λ\tilde{L}_{C}⁻¹\tilde{B}₁s₁. (4.12)

Based on (3.6) in Lemma 1, f and [symbol] ₂ must be B-orthogonal. In addition, from (4.9) and (4.12), since

\tilde{B}₁^{T}f=λ(\tilde{B}₁^{T}\tilde{L}C⁻¹\tilde{B}₁)s₁=s₁,

the B-orthogonality of f and [symbol] ₂ implies that

$${f}^{T } Bf = {f}^{T} ( \tilde{B} + ( \frac{1}{{n}_{b}} B {2}_{} ) {( B {2}_{} )}^{T} ) f = {f}^{T} {\tilde{B}}_{1} {\tilde{B}}_{1}^{T} f = {s}_{1}^{T} {s}_{1} .$$

Consequently, f^{T}Bf=1 provided that s₁^{T}s₁=1.

### Remark 2.

The difference between these two eigenproblems (3.9) and (4.9) is remarked. In the first place, the reduced problem (4.9) excludes the possibility of interference induced by the kernel of L_{C} (Theorem 1 (i)). Second, the inverted CDSEP (4.9) is used to seek the smallest positive eigenvalue directly through any well-known iterative methods without the need to previously construct the coefficient matrix. To put it another way, effective techniques are devised to compute the matrix-vector multiplication \tilde{B}₁q, and to solve the linear system \tilde{L}_{C}p=r for given vectors q, r. Thus, for large meshes, to determine the smallest positive eigenvalue of the original GEP (3.3) and the associated eigenvector through the CDSEP (4.9) is more efficient and robust than the equivalent problem (3.9).

### SHILA: The Skew-Hamiltonian Isotropic Lanczos Algorithm

Subsequently, we will propose a novel and efficient eigensolver for the SEP Ms=λs with a symmetric skew-Hamiltonian operator M. In this case, M is given by \tilde{B}₁^{T}\tilde{L}_{C}⁻¹\tilde{B}₁ and the practical realization will be discussed in the following description.

Let n be a positive integer. Suppose that M [symbol] ^{2n×2n} is a skew-Hamiltonian matrix (not necessarily symmetric). Van Loan showed that there is a 2n×2n symplectic and orthogonal matrix of the form [Q JQ] with Q [symbol] ^{2n×n} and

$$J = [ \begin{matrix}0 & {I}_{n} \\ - {I}_{n} & 0\end{matrix} ]$$

such that

$$[ \begin{matrix}{Q}^{T} \\ {( JQ )}^{T}\end{matrix} ] M [ \begin{matrix}Q & JQ\end{matrix} ] = [ \begin{matrix}H & F \\ 0 & {H}^{T}\end{matrix} ] , \qquad ( 4.13 )$$

where H [symbol] ^{n×n} is upper Hessenberg and F [symbol] ^{n×n} is skew-symmetric. The matrix structure in (4.13) presents the multiplicity of the eigenvalues of M. For each double eigenvalue of M, one copy resides in H, and the other copy is in H^{T}. Consequently, the eigenvalues of M can be captured by H without missing any information.

Recall that the Krylov subspace Kₖ(M,q) of M with respect to q and k is defined by

Kₖ(M,q)=span{q,Mq,M²q, . . . ,M^{k-1}q}.

It can be shown that when M is skew-Hamiltonian, the generated Krylov subspace is isotropic, which means that s^{T}Jt=0 for all s,tεKₖ(M,q). To compute an orthonormal and symplectic basis (qⱼ)ⱼ₌₁^{k} of such a k-dimensional isotropic Krylov subspace, Mehrmann and Watkins introduced the so-called isotropic Arnoldi process

$${q}_{j + 1} {h}_{j + 1 , j} = {Mq}_{j} - {\sum }_{i = 1}^{j} {q}_{i} {h}_{ij} - {\sum }_{i = 1}^{j} {Jq}_{i} {r}_{ij} , j = 1 , … , k - 1 , \qquad ( 4.14 )$$

where hᵢⱼ=qᵢ^{T}Mqⱼ, h_{j+1,j} is chosen to be a positive number so that

∥qⱼ₊₁∥₂=1 and rᵢⱼ=(Jqᵢ)^{T}Mqⱼ. (4.15)

For a skew-Hamiltonian matrix M with exact arithmetic, rᵢⱼ in (4.14) will all be zero, so the isotropic Arnoldi process and the standard Arnoldi process are theoretically equivalent. However, in practical implementation, some tiny values for rᵢⱼ caused by roundoff error will destroy the isotropic property. To prevent the loss of isotropicity, we need to subtract out the tiny component Jqᵢrᵢⱼ. The process terminates after n−1 steps, as {q₁, qₙ, Jq₁, . . . , Jqₙ} forms an orthonormal basis of [symbol] ²ⁿ. Based on the isotropic Arnoldi process, Mehrmann and Watkins further developed the SHIRA method, which is the abbreviation of skew-Hamiltonian, isotropic, implicitly restarted shift-and-invert Arnoldi method, for solving for the large-scale SEP Ms=λs with the real skew-Hamiltonian operator M.

For the model problem, \tilde{B}₁^{T}\tilde{L}_{C}⁻¹\tilde{B}₁ in (4.9) is skew-Hamiltonian, and, additionally, itself is symmetric. In this case, the equality in (4.13) can be reduced as

$$[ \begin{matrix}{Q}^{T} \\ {( JQ )}^{T}\end{matrix} ] M [ \begin{matrix}Q & JQ\end{matrix} ] = [ \begin{matrix}T & 0 \\ 0 & T\end{matrix} ] ,$$

where T is an n×n tridiagonal matrix. Based on the isotropic Arnoldi process, an isotropic Lanczos procedure is introduced for a symmetric skew-Hamiltonian matrix. As M itself is symmetric, the associated orthogonalization in (4.14) possesses a much simpler form, given by

$${q}_{j + 1} {β}_{j} = {Mq}_{j} - {q}_{j - 1} {β}_{j - 1} - {q}_{j} {α}_{j} - {\sum }_{i = 1}^{j} {Jq}_{i} {r}_{ij} , \\ j = 1 , … , k - 1 , \qquad ( 4.16 )$$

where

αⱼ=qⱼ^{T}Mqⱼ, βⱼ=qⱼ₊₁Mqⱼ,

and rᵢⱼ is given as in (4.15) which also equals zero in exact arithmetic. The equation (4.16) can be represented by the matrix form

MQₖ=QₖTₖ+JQₖRₖ+qₖ₊₁βₖeₖ^{T}, (4.17)

where Tₖ=tridiag (βⱼ₋₁,αⱼ,βⱼ) [symbol] ^{k×k} is tridiagonal, Rₖ=[rᵢⱼ] [symbol] ^{k×k} is upper triangular, Qₖ=[q₁ . . . qₖ]ε [symbol] ^{2n×k} is orthonormal and isotropic, and q₊₁ is a suitable vector satisfying

Qₖ^{T}qⱼ₊₁=0 and (jQₖ)^{T}qⱼ₊₁=0. (4.18)

According to (4.17) and (4.18), the following is obtained

$${Q}_{k}^{T} {MQ}_{k} = {T}_{k} and \\ [ \begin{matrix}{Q}^{T} \\ {( JQ )}^{T}\end{matrix} ] M [ \begin{matrix}Q & JQ\end{matrix} ] = [ \begin{matrix}{T}_{k} & 0 \\ 0 & {T}_{k}\end{matrix} ] .$$

Not only does the isotropic Lanczos process generate an orthonormal basis Qₖ for the k-dimensional isotropic Krylov subspace, but also it splits the duplicate eigenvalues of M when M is projected onto the subspace generated by Qₖ. So, to compute eigenvalues of Hₖ, and hence the Ritz values of M, each eigenvalue once is obtained, not twice. The critical essence of this numerical approach is that if we try to find, for instance, 2m's distinct eigenvalues from M, then our method can produce 2m's distinct eigenvalues from Tₖ, not a copy of m's different eigenvalues.

Suppose that (θ, z) is an eigenpair of Tₖ, i.e., Tₖ, z=θz. Then (θ; Qₖz) is a Ritz pair of M. Then from (4.17) and (4.18) again, the following is obtained

$$\begin{matrix}{‖ ( M - θ I ) {Q}_{k} z ‖}_{2} = {‖ ( {MQ}_{k} - {T}_{k} {Q}_{k} ) z ‖}_{2} \\ = {‖ {JQ}_{k} {R}_{k} z + {q}_{k + 1} {β}_{k} {e}_{k}^{T} z ‖}_{2} \\ = {‖ [ \begin{matrix}{R}_{k} z \\ {β}_{k} {e}_{k}^{T} z\end{matrix} ] ‖}_{2} \\ \approx \vert {β}_{k} \vert \vert {e}_{k}^{T} z \vert .\end{matrix} \qquad ( 4.19 )$$

The approximately equal sign in (4.19) holds since Rₖ is an upper triangular matrix with tiny, or even zero, entries. Equation (4.19) provides us a simple and easy estimation of the residual ν(M−θI)Qₖz∥₂ as a Ritz pair (θ; Qₖz) of M is obtained via the SHILA method.

Remark 3.

If the classical Lanczos method is directly used to solve the CDSEP (4.9), the required iteration number may be more than the result of the SHILA method. This is because the double eigenvalues will hold each other up and tend to converge simultaneously. In contrast, the SHILA method can effectively exclude the inference of double eigenvalues and make efforts to the desired one.

### Practical Implementations

The techniques of nonequivalence deation and null-space free compression successfully reduce the original GEP (3.3) to a small-scale CDSEP (4.9). On the implementation, it is neither possible nor necessary to construct the inverse of deflating matrix \tilde{L}_{C} in (4.2a) and the compressed matrix \tilde{B}₁ in (5.1).

In this section, we focus on how to efficiently compute the matrix-vector multiplication (\tilde{B}₁\tilde{L}_{C}⁻¹\tilde{B}₁)q for a given vector q when we perform the SHILA iteration through the structures of “undeflated” matrices L_{C} and B themselves.

### Explicit Eigendecomposition and Implicit Multiplication of \tilde{B}

As \tilde{B} is a block-diagonal matrix consisting of \tilde{D} in (4.2b), it is sufficient to determine the eigendecomposition of \tilde{D}.

Let Iᵢ and I_{b}={b₁, . . . , bₙ_{_{b}}} denote ordered index sets of the interior vertices (including interior boundary vertices) and the (external) boundary vertices, respectively. Let bₖ be

an nᵥ-vector defined by

$${( {b}_{k} )}_{i} = \{ \begin{matrix}\frac{1}{\sqrt{k ( k + 1 )}} , & i = {b}_{1} , … , {b}_{k} , \\ \frac{- k}{\sqrt{k ( k + 1 )}} , & i = {b}_{k + 1} , \\ 0 , & otherwise ,\end{matrix} \\ k = 1 , … , {n}_{b} - 1. \qquad ( 5.1 )$$

### Lemma 3.

The deflated matrix \tilde{D} in (4.2b) has semisimple eigenvalues 0 and 1 with algebraic multiplicity nᵢ+1 and n_{b}−1, respectively. Moreover, the kernel of \tilde{D} has an orthonormal basis

$$\{ {e}_{j} , \frac{1}{\sqrt{{n}_{b}}} d \text{:} j ∈ {ℐ}_{i} \}$$

where d is defined in (4.1); the eigenspace of \tilde{D} corresponding to the eigenvalue 1 is spanned by the orthonormal set {b1, . . . , b_{nb-1}}.

### Proof.

For simplicity, first reorder the columns and rows of D in (3.2) to get

$$D = \begin{matrix}{n}_{b} \\ {n}_{i}\end{matrix} {[ \begin{matrix}{I}_{{n}_{b}} & 0 \\ 0 & 0\end{matrix} ]}^{\begin{matrix}{n}_{b} & {n}_{i}\end{matrix}} . \\ Then , \\ \tilde{D} = D - \frac{1}{{n}_{b}} {dd}^{T} = [ \begin{matrix}{I}_{{n}_{b}} - \frac{1}{{n}_{b}} {1}_{{n}_{b}} {1}_{{n}_{b}}^{T} & 0 \\ 0 & 0\end{matrix} ] , \\ d = D {1}_{n} = [ \begin{matrix}{1}_{{n}_{b}} \\ 0\end{matrix} ] , {ℐ}_{b} = \{ 1 , … , {n}_{b} \} , {ℐ}_{i} = \{ {n}_{b} + 1 , … , n \} ,$$

and (5.1) can be rewritten as

$${b}_{k} = \frac{1}{\sqrt{k ( k + 1 )}} [ \begin{matrix}{1}_{k} \\ - k \\ 0\end{matrix} ] , k = 1 , … , {n}_{b} - 1. \qquad ( 5.2 )$$

The orthogonality of the nv vectors

$$\{ {b}_{i} , … , {b}_{{n}_{b} - 1} , \frac{1}{\sqrt{{n}_{v}}} d , {e}_{{n}_{b} + 1} , … , {e}_{{n}_{v}} \}$$

is straightforward via a simple calculation. It is obvious to see that \tilde{D}d=0 and \tilde{D}eₖ=0 for each kεIᵢ which imply that the nᵢ+1 vectors,

$$\frac{1}{\sqrt{{n}_{b}}} d , {e}_{{n}_{b} + 1} , … , {e}_{{n}_{v}} ,$$

are eigenvectors of \tilde{D} corresponding to the zero eigenvalue. On the other hand, owing to the orthogonality of d^{T}bₖ=0 for k=1, . . . , n_{b}−1, \tilde{D}bₖ=Dbₖ=bₖ is obtained. This shows that the n_{b}−1 vectors, b1, . . . , b_{nb-1}, are eigenvectors of \tilde{D} corresponding to the eigenvalue 1.

Let E₀ε [symbol] ⁿ^{ᵥ}^{×(n}^{₁}⁺¹⁾ and E₁ε [symbol] ⁿ^{ᵥ}^{×(n}^{₂}⁻¹⁾ be, respectively, defined by

$$\begin{matrix}{E}_{0} = [ \begin{matrix}{e}_{{j}_{1}} & … & {e}_{{j}_{{n}_{1}}} & \frac{1}{\sqrt{{n}_{b}}} d\end{matrix} ] , {j}_{1} , … , {j}_{{n}_{i}} ∈ {ℐ}_{i} , & ( 5.3 a ) \\ {E}_{1} = [ \begin{matrix}{b}_{1} & … & {b}_{{n}_{b} - 1}\end{matrix} ] . & ( 5.4 b )\end{matrix}$$

By Lemma 3, it is learned that E₀, E₁ are column orthonormal matrices with E₀^{T}E₁=0. Moreover, column vectors of the following enlarging matrices

$${\tilde{B}}_{0} = [ \begin{matrix}{E}_{0} & 0 \\ 0 & {E}_{0}\end{matrix} ] \\ and \\ {\tilde{B}}_{1} = [ \begin{matrix}{E}_{1} & 0 \\ 0 & {E}_{1}\end{matrix} ] \qquad ( 5.4 )$$

are orthonormal eigenvectors of \tilde{B} corresponding to its eigenvalues 0 and 1, respectively (cf. Lemma 2). Based on the above deductions, it is concluded that \tilde{B} is orthogonal diagonalizable,

$$\tilde{B} = [ \begin{matrix}{\tilde{B}}_{0} & {\tilde{B}}_{1} ] [ \begin{matrix}0 & 0 \\ 0 & {I}_{2 ( {n}_{b} - 1 )}\end{matrix} ] [ \begin{matrix}{\tilde{B}}_{0}^{T} \\ {\tilde{B}}_{1}^{T}\end{matrix} ] = {\tilde{B}}_{1} {\tilde{B}}_{1}^{T} ,\end{matrix}$$

which is an explicit decomposition formula.

Although the low-rank compressed matrix \tilde{B}₁ can be explicitly constructed, there is still another problem on the dense factorization. Nevertheless, it is needed to know how to compute the product of \tilde{B}₁ (or \tilde{B}₁^{T}) and a given vector when the SHILA method is used to solve the desired eigenpair. Fortunately, the specific structure of \tilde{B}₁ provides an implicitly computational scheme of matrix-vector multiplication without explicitly generating \tilde{B}₁ itself beforehand. From (5.4), it is thus sufficient to consider the matrix-vector multiplications: E₁q and E₁^{T}p for given qε [symbol] ⁿ^{_{b}}⁻¹ and p [symbol] ^{nv}. In order to make the expression clearer, the reordering notations are adapted so that each column vector bₖ of E₁ in (5.3b) is of the form (5.2). The actual computing can be achieved via appropriate index correspondences. For a fixed vector q=[q₁ . . . qₙ_{_{b}}₋₁]^{T}, E₁q is an n-vector given by

$${( {E}_{1} q )}_{i} = \{ \begin{matrix}( {\sum }_{k = 1}^{{n}_{b} - 1} \frac{1}{\sqrt{k ( k + 1 )}} qk ) - & \frac{i - 1}{\sqrt{{( i - 1 )}_{i}}} {q}_{i - 1} , & i = 1 , … , {n}_{b} - 1 , \\ - \frac{{n}_{b} - 1}{\sqrt{( {n}_{b} - 1 ) {n}_{b}}} {q}_{{n}_{b} - 1} , & & i = {n}_{b} , \\ 0 , & & i = {n}_{b} + 1 , … , {n}_{v} ,\end{matrix} \qquad ( 5.5 )$$

where q₀=0. Similarly, the product of and the vector P=[p₁ . . . p_{n]}^{T} is the following (n_{b}−1)-vector

$${( {E}_{1}^{T} p )}_{i} = \frac{1}{\sqrt{i ( i + 1 )}} {\sum }_{k = 1}^{i} ( {p}_{k} - {p}_{i + 1} ) , \\ i = 1 , … , {n}_{b} - 1. \qquad ( 5.6 )$$

### The Inverse of \tilde{L}_{C}

When the nonequivalence transformation is applied and the deating GEP (4.5) is reduced to the small-scale problem (4.9), at first glance, it seems definitely to modify L_{C} by a rank-2 updating as presented in (4.2a). It is not advisable to construct the deflated matrix \tilde{L}_{C} as well as its inverse since the symmetric matrix (B [symbol] ₂)(B [symbol] ₂)^{T} in (4.2), dependent on the boundary vertices, may be practically non-sparse. However, it is not necessary to actually compute \tilde{L}_{C} since an equivalent way for solving the linear systems whose coefficient matrix is \tilde{L}_{C} can be found.

To perform the SHILA method for solving the CDSEP (4.9) with the symmetric positive definite and skew-Hamiltonian matrix \tilde{B}₁\tilde{L}_{C}⁻¹\tilde{B}₁, the following linear system must be solved

\tilde{L}_{C}p=q (5.7)

with a given 2nᵥ-vector q in each step for the subspace expansion. Since \tilde{L}_{C} is a rank-2 updating of L_{C}, this motivates us to solve the linear system (5.7) based on the Sherman-Morrison-Woodbury formula (SMWF). Consider \tilde{G}= [symbol] where Gε [symbol] ^{n×n} is nonsingular, U, V^{T}ε [symbol] ^{n×r} are of rank r<<n so that Iᵣ+V^{T}G⁻¹U is a r×r invertible matrix. The SMWF suggests computing \tilde{G}⁻¹ through the identity

\tilde{G}⁻¹=(Iₙ−WV^{T}G⁻¹ with W=G⁻¹U(Iᵣ+V^{T}G⁻¹U)⁻¹. (5.8)

This formula is valid only if G is nonsingular while L_{C} fails to satisfy this requirement because of the zero row sum property (see (4.2a)). However, we can rewritten \tilde{L}_{C} as

$$\begin{matrix}\begin{matrix}{\tilde{L}}_{C} = {L}_{C} + \frac{1}{{n}_{b}} ( B ) {( B )}^{T} \\ = ( {L}_{C} + {e}_{1} {e}_{1}^{T} + {e}_{{n}_{v} + 1} {e}_{{n}_{v} + 1}^{T} ) + \frac{1}{{n}_{b}} ( B ) {( B )}^{T} - \\ {e}_{1} {e}_{1}^{T} - {e}_{{n}_{v} + 1} {e}_{{n}_{v} + 1}^{T} \\ = {L}_{C}^{+} + {[ \frac{1}{{n}_{b}} B - {e}_{1} - {e}_{{n}_{v} + 1} ] [ B {e}_{1} {e}_{{n}_{v} + 1} ]}^{T} ,\end{matrix} & ( 5.9 ) \\ where & \\ {L}_{C}^{+} ≡ {L}_{C} + {e}_{1} {e}_{1}^{T} + {e}_{{n}_{v} + 1} {e}_{{n}_{v} + 1}^{T} = [ \begin{matrix}{K}^{+} & S \\ - S & {K}^{+}\end{matrix} ] , {K}^{+} = K + {e}_{1} {e}_{1}^{T} . & ( 5.10 )\end{matrix}$$

To contrast (5.9) with the SMWF formula (5.8), it is seen that n=2nᵥ, r=4, G=L_{C}⁺, V=[B [symbol] ₂ e₁ eₙ_{ᵥ}₊₁] and W can be expressly formulated as follows. Let x; y [symbol] ^{nv} satisfy

$${L}_{C}^{+} [ \begin{matrix}x \\ y\end{matrix} ] = \frac{1}{{n}_{b}} [ \begin{matrix}d \\ 0\end{matrix} ] ,$$

where d is defined as in (4.1).

### Set

$$χ = \frac{1}{{n}_{b}} ( {\underline{d}}^{T} x + 1 ) , η = \frac{1}{{n}_{b}} ( {d}^{T} y ) , σ = {( {x}_{1}^{2} + {\dot{y}}_{1}^{2} )}^{- 1} {\dot{x}}_{1} , τ = {( {x}_{1}^{2} + {y}_{1}^{2} )}^{- 1} {y}_{1}$$

with x₁=e₁^{T}x and y₁=e₁^{T}y. Then

$$W = [ \begin{matrix}\frac{{1}_{{n}_{v}}}{{n}_{b}} & 0 & h & k \\ 0 & \frac{{1}_{{n}_{v}}}{{n}_{b}} & - k & h\end{matrix} ] ,$$

where h=σx+τy−(σx+τη)1ₙ_{ᵥ} and k=τx−σy−(τx−ση)1ₙ_{ᵥ}.

This representation views \tilde{L}_{C} as a rank-4 updating of L_{C}⁺. L_{C}⁺ itself is a simple perturbation, virtually no-cost, on the first diagonal element of Le as well as its dual. From (5.10), it can be seen that L_{C}⁺ completely preserves the structure and sparsity of L_{C}, and, in general, L_{C}⁺ will be a nonsingular matrix. Therefore, a feasible alternative for applying the SMWF to \tilde{L}_{C} is presented for solving (5.7).

Remark 4.

The perturbation formula (5.10) can be written in a more general form

K⁺=K+ρeₖeₖ^{T}, ρ>0, 1≦k≦nᵥ.

In other words, we can select suitable quantity p and vertex index k to destroy the zero row sum property of K so that K+ (and hence L_{C}⁺) becomes a nonsingular matrix. Fixedρ>0 and 1≦k≦nᵥ, the 2 nᵥ-vector e1 and its dual one eₙᵥ₊₁ in (5.9) and (5.10), of course, will be changed accordingly. The resulting matrix L_{C}⁺ and the original one L_{C} always have the same structure and sparsity as shown in (5.9) and (5.10). The perturbation term as well as magnitude is adaptively chosen to construct an invertible matrix L_{C}⁺ so that SMWF (5.8) is applicable for solving the linear system (5.7).

### SHILA for Spectral Conformal Parameterizations

Algorithm 5.1 summarizes the SHILA method for solving the smallest positive eigenvalue and corresponding eigenvector of the GEP (3.3) based on a null-space free compression technique to the deflated matrix pair (\tilde{L}_{C}, \tilde{B}) in (4.2).
The Algorithm 5.1 of the SHILA Procedure for Spectral Conformal Parameterizations is stated as the following algorithm.
Input: The matrix L_{C} in (2.7); a random unit vector q1; the maximum iteration maxit and the tolerance tol.
Output: (λ; f) where λ is the smallest positive eigenvalue of the GEP (3.3) and f is the associated eigenvector.

### 1: % Initinalization

2: Set Q₁=q₁ and P₀=[ ];
3: L_{C}←L_{C}⁺ by (5.10);
4: % The SHILA procedure
5: for j=1; 2; . . . ; maxit do
6: % Compute q=\tilde{B}₁^{T}\tilde{L}_{C}⁻¹\tilde{B}₁qj

### 7: Compute

$$t = {\tilde{B}}_{1} {q}_{j} = [ \begin{matrix}{E}_{1} & 0 \\ 0 & {E}_{1}\end{matrix} ] {q}_{j}$$

implicitly by (5.5);
8: Solve \tilde{L}_{C}pⱼ=t by SMWF with (5.9)-(5.10);
9: set Pⱼ=[Pⱼ₋₁, pⱼ]=\tilde{L}_{C}⁻¹\tilde{B}₁Qⱼ

### 10: Compute

$$q = {\tilde{B}}_{1}^{T} {P}_{j} = [ \begin{matrix}{E}_{1}^{T} & 0 \\ 0 & {E}_{1}^{T}\end{matrix} ] {P}_{j}$$

implicitly by (5.6);
11: % Orthogonalization process
12: Compute αⱼ=qⱼ^{T}q;
13: q←q−αⱼ^{T}q;
14: if j>1 then
15: q←q−βⱼ₋₁qⱼ₋₁;
16: end if
17: % Isotropic orthogonalization process
18: Compute r=(JQⱼ)^{T}q, where J is the matrix (2.8);
19: q←q−(JQⱼ)r;
20: % Compute the j+1 Lanczos vector qⱼ₊₁
21: Compute βⱼ=∥q∥₂;
22: Set qⱼ₊₁=q=βⱼ and Qⱼ₊₁=[Qⱼ, qⱼ₊₁]
23: % Compute approximate eigenpair
24: Compute the largest magnitude eigenvalue θ and the associated eigenvector z of Tj where

$${T}_{1} := [ {α}_{1} ] , {T}_{2} := [ \begin{matrix}{α}_{1} & {β}_{1} \\ {β}_{1} & {α}_{2}\end{matrix} ] and {T}_{j} := [ \frac{{T}_{j - 1}}{θ {β}_{j - 1}} \vert \frac{{θ}_{{β}_{j - 1}}}{{α}_{j}} ] , j \geq 3 ;$$

25: % Check residual
26: if |βⱼ∥eⱼ^{T}z|<tol then
27: Set λ=θ⁻¹ and f=λPⱼz;
return (λ; f)
28: end if
29: end for

Then some key points for our MATLAB implementation of Algorithm 5.1 are explained. (i) All matrix-vector multiplications, including B in (3.2), \tilde{B} in (4.2b) and its range basis \tilde{B}₁ in (4.8), can be performed by multiply-add operations on vectors with appropriate indices. Thus it does not require any extra cost to construct and store these matrices. (ii) The matrix left division (i.e., \) is used together with SMWF to solve the linear system at each isotropic Lanczos step. If the matrix size is extremely large, any suitable iterative method can be a feasible alternative. (iii) To seek the eigenpair of Tⱼ with largest magnitude, the eig function is called to accomplish this task. (iv) Finally, and most importantly, the statements at lines 9 and 27 of Algorithm 5.1 which need further explanations. Suppose we obtain an desired eigenpair (θ, z) of Tₖ at step k, i.e., (θ, z) satisfies the stopping criterion (4.19) at line 26 of Algorithm 5.1. Then (θ, Qₖz) is a Ritz pair of the CDSEP (4.9). With the aid of (4.12), it is learned that

λ=θ⁻¹ and f=λ\tilde{L}_{C}⁻¹\tilde{B}₁Qₖz (5.11)

are the approximate eigenvalue and the associated eigenvector of our original eigenproblem (3.3). Therefore, to get the desired eigenvector, (5.11) indicates that two matrix-vector multiplications need to be performed for solving one linear system. But this is only a theoretical expression. In practice, the pre-stored matrix Pₖ in line 9 of Algorithm 5.1
collects the computational results of \tilde{L}_{C}⁻¹\tilde{B}₁Qₖ in the past efforts in lines 7 and 8. Thus z is transformed back to the vector f in (5.11), actually only one matrixvector multiplication together with a scalar product as shown in line 27 of Algorithm 5.1 need to be computed, without extra cost for solving a linear system.

### Numerical Experiments

The efficiency and accuracy of the novel numerical technique, SHILA (Algorithm 5.1), have been demonstrated to solve the new derived CDSEP (4.9) for the computation of discrete conformal parameterizations of various mesh models.

### Performance

In experiments, all numerical demonstration was carried out using MATLAB R2013a on a MacBook Pro Retina with 2.6 GHz Intel Core i5 processor and 8 GB of RAM. The maximum iteration maxit and the stopping tolerance tol in Algorithm 5.1 are taken as maxit=30 and tol=10⁻⁵ respectively.

In order to show the advantages of SHILA, the classical Lanczos method is additionally applied to solve our CDSEP (4.9). Moreover, the performances of the modified GEP (3.7) and the Schur complement reduction (3.9) are also considered. To solve the modified GEP (3.7), the eigs function is called from the MATLAB library to find the largest eigenvalue and associated eigenvector of (3.7) with a function handle to compute the matrix-vector product on the left-hand side of (3.7) without explicitly forming this matrix. For the approach introduced in M. Alexa, et al, Discrete laplacians on general polygonal meshes. In ACM SIGGRAPH 2011 PAPERS, SIGGRAPH' 1, pages 102:1-102:10, New York, N.Y., USA, 2011. ACM, first the coefficient matrix of the Schur complement is computed as in (3.9) and subsequently the reduced eigenvalue problem is solved.

To express numerical results of these four methods, SL_{CDSEP}, L_{CDSEP}, E_{MGEP} and SC_{RGEP} are denoted as follows:
SL_{CDSEP}: Applying SHILA (Algorithm 5.1) to solve CDSEP (4.9).
L_{CDSEP}: Applying the classical Lanczos method to solve CDSEP (4.9).
E_{MGEP}: Applying the MATLAB procedure eigs to solve the modified GEP (3.7).
SC_{RGEP}: Applying Schur complement approach to solve the reduced GEP (3.9).

SL_{CDSEP}, L_{CDSEP}, and SC_{RGEP} need to solve linear systems and to hunt for desired eigenpair(s) from small-scaled problems. For SL_{CDSEP} and L_{CDSEP}, first compute the Cholesky factorization of L_{C}⁺ by the MATLAB chol function for generating the orthonormal bases of the isotropic Krylove subspace or just the Krylov subsapce. Thus, for SL_{CDSEP} and L_{CDSEP}, the Cholesky factorization of L_{C}⁺ and the SMWF formula (5.8) are applied to solve the linear system in line 8 of Algorithm 5.1. For the SC_{RGEP} approach, the MATLAB built-in functions mldivide (i.e., \) is directly adopted to treat corresponding linear systems. At line 24 in Algorithm 5.1 of the SHILA (and the corresponding step for the Lanczos method), eig is called to compute all eigenpairs of the small matrix Tⱼ at each step j and then select the wanted candidate to check residual. For the SC_{RGEP} method, eigs will be invoked to return several alternative eigenpairs. Note that the reduced system (3.9) still has double eigenvalues including the zeros, so eigs are called to compute 4 eigenvalues with smallest magnitude—two of them are 0 and the others are (theoretically) identical to the smallest positive eigenvalue of the GEP (3.3).

To quantitatively measure the conformality, we adapt the quasi-conformal (QC) distortion. The QC distortion factor is computed per mesh triangle face as the ratio

$$\frac{Γ}{γ\_} ,$$

where Γ and γ are larger and smaller eigenvalues of the Jacobian of the map. The ideal conformality is 1, larger value for worse conformality.

TABLE 1L
CPU time and number of iterations. Note that for the Uzzano model, SC_{RGEP} did
not complete and encounter the “out of memory” error in 2331 seconds after.

| | | | | Time (#Its) [sec] | | | | | |
|---|---|---|---|---|---|---|---|---|---|
| Model | nᵥ | n_{b} | λ | SL_{CDSEP} | | L_{CDSEP} | | E_{MG-EP} | SC_{R-GEP} |
| Susan | 5161 | 321 | 4.8045e−6 | 0.1 | (7) | 0.1 | (7) | 0.1 | 0.7 |
| Fandisk | 6699 | 450 | 2.6814e−6 | 0.1 | (8) | 0.1 | (8) | 0.1 | 0.8 |
| Saddle | 8321 | 256 | 3.3305e−7 | 0.1 | (6) | 0.1 | (11) | 0.4 | 1.0 |
| Foot | 10211 | 454 | 1.9270e−6 | 0.1 | (8) | 0.1 | (13) | 0.3 | 1.1 |
| Gargoyle | 10229 | 456 | 1.6899e−5 | 0.1 | (10) | 0.1 | (10) | 0.4 | 1.2 |
| Beetle | 15053 | 375 | 5.2974e−7 | 0.2 | (7) | 0.3 | (12) | 0.3 | 6.5 |
| Sophie | 15282 | 562 | 2.1015e−6 | 0.2 | (7) | 0.3 | (13) | 0.3 | 4.2 |
| Pipes | 20304 | 64 | 1.0470e−4 | 0.3 | (6) | 0.3 | (6) | 1.1 | 3.7 |
| Dino | 24605 | 1248 | 1.0443e−6 | 0.3 | (10) | 0.4 | (17) | 0.9 | 7.8 |
| Bunny | 35190 | 927 | 1.9835e−6 | 0.6 | (10) | 0.6 | (10) | 1.9 | 15.0 |
| Hand | 37234 | 1508 | 2.0250e−7 | 0.6 | (9) | 0.8 | (15) | 1.7 | 26.0 |
| Camel | 40240 | 2334 | 5.4112e−7 | 0.7 | (11) | 1.0 | (20) | 2.1 | 45.4 |
| Vase-Lion | 178491 | 625 | 6.8350e−6 | 2.6 | (9) | 2.6 | (9) | 3.8 | 59.2 |
| Isis | 188144 | 1977 | 6.4689e−8 | 4.4 | (10) | 5.0 | (15) | 11.6 | 679 |
| Max Planck | 199169 | 293 | 2.7225e−6 | 4.3 | (7) | 4.3 | (7) | 11.8 | 34.8 |
| Chinese-Lion | 255284 | 928 | 7.5866e−6 | 5.7 | (11) | 5.7 | (11) | 9.2 | 371 |
| Caesar | 387900 | 1634 | 9.2161e−7 | 11.3 | (9) | 13.4 | (16) | 48.6 | 1227 |
| Bimba | 423713 | 1308 | 8.2092e−8 | 7.6 | (8) | 8.8 | (13) | 23.8 | 1180 |
| Uzzano | 946451 | 2581 | 1.4856e−7 | 36.3 | (10) | 61.8 | (17) | 65.9 | — |

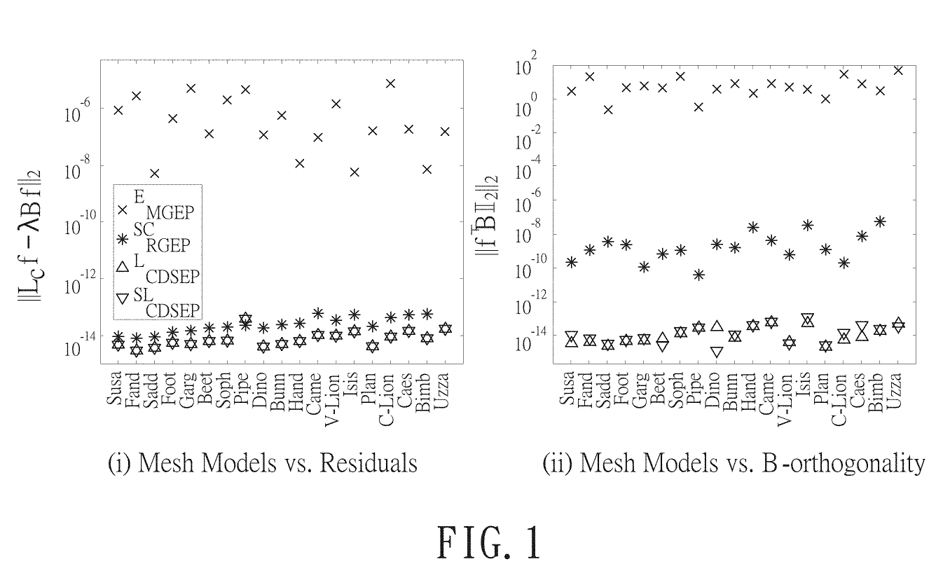

Table 1 shows the computational time of these methods. For SL_{CDSEP} and L_{CDSEP}, the individual iteration numbers are additionally presented. Moreover, once the desired eigenpair (λ; f) is obtained from SL_{CDSEP}, L_{CDSEP}, E_{MGEP} or SC_{RGEP}, the residual ∥L_{C}f−λBf∥₂ and ∥f^{T}B [symbol] ₂∥₂ for each approach as shown in FIG. 1. Note that if f is the eigenvector computed from E_{MGEP}, then, in general, ∥f^{T}Bf−1∥₂>̅>̅0. Thus, in this case, f should be further normalized by

$$\frac{\dot{f}}{\sqrt{{f}^{T} Bf}} .$$

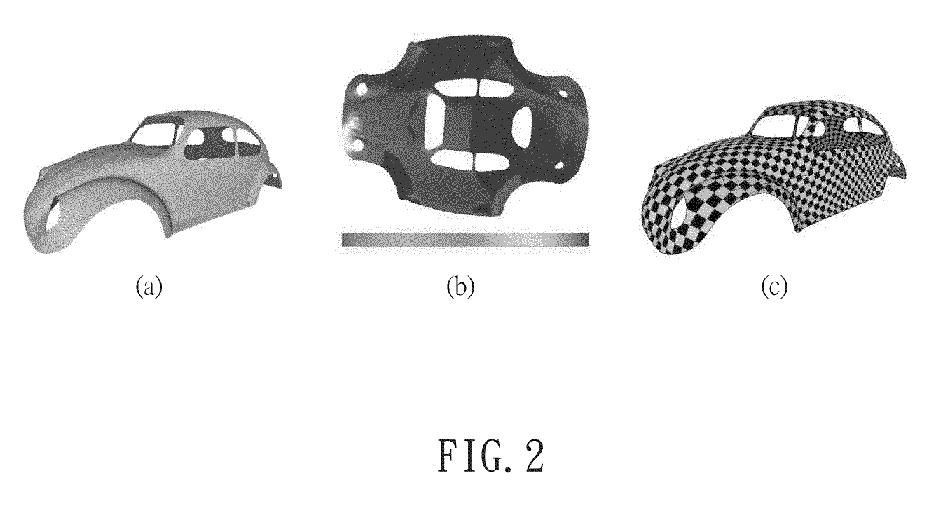

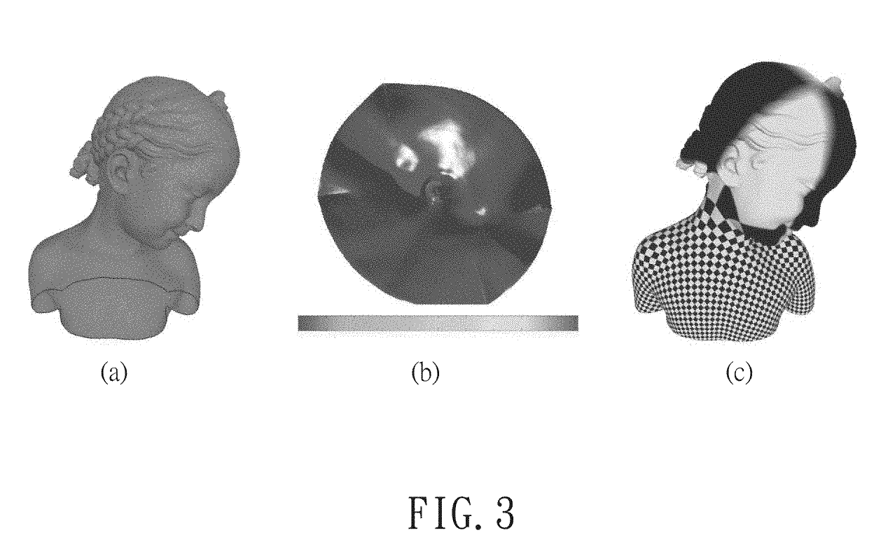

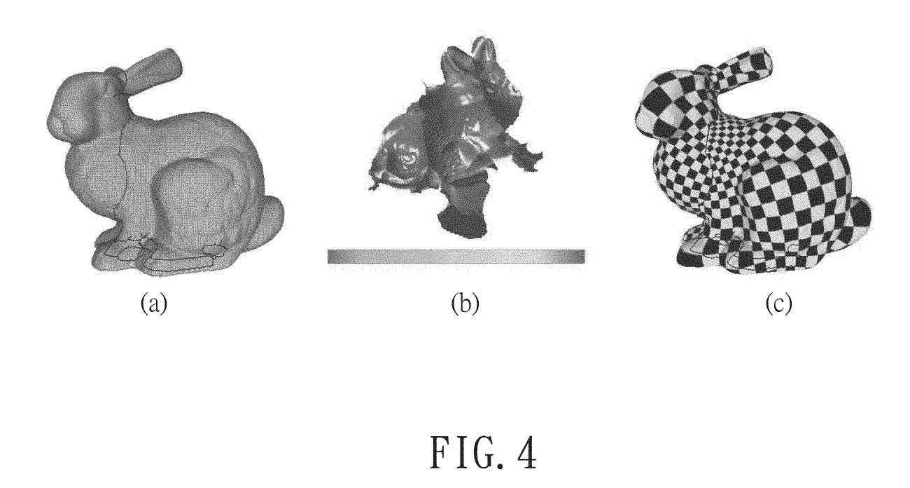

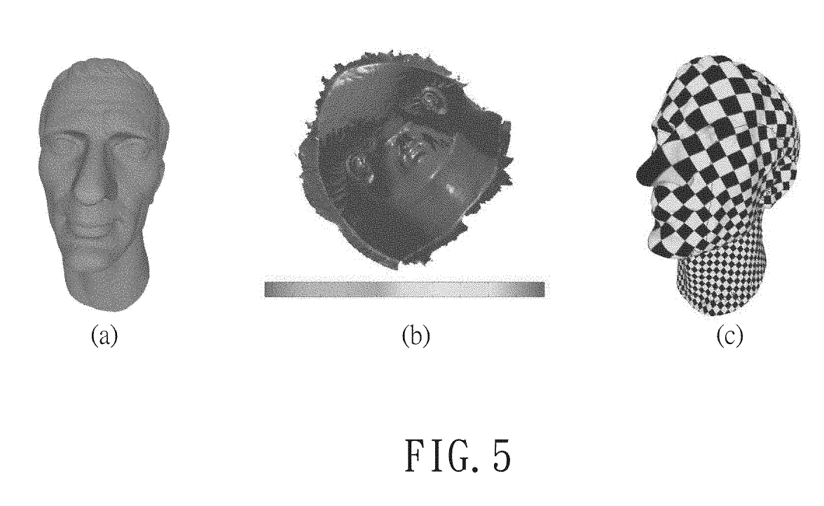

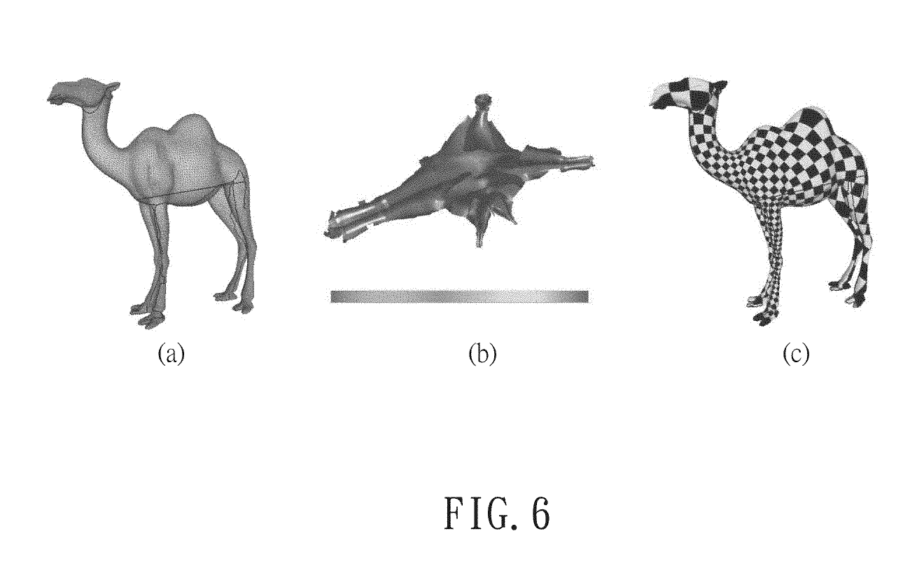

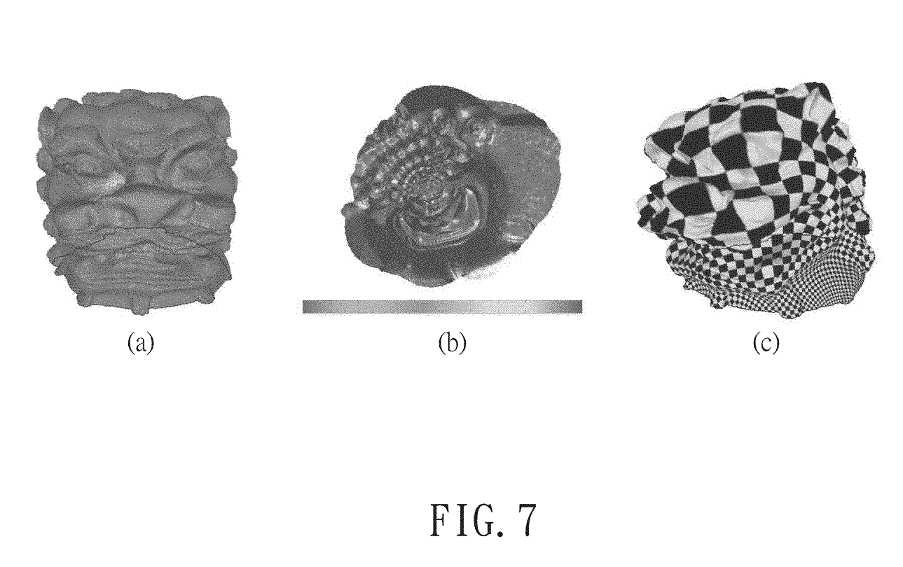

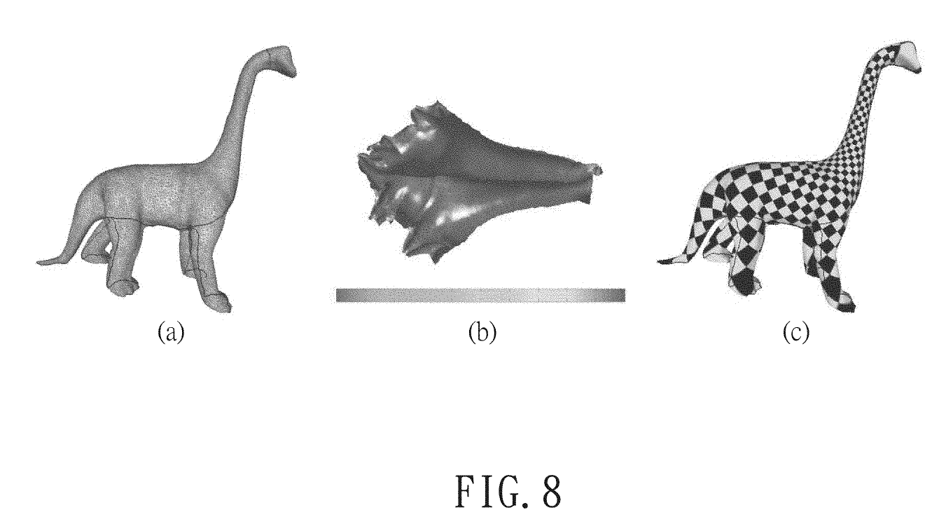

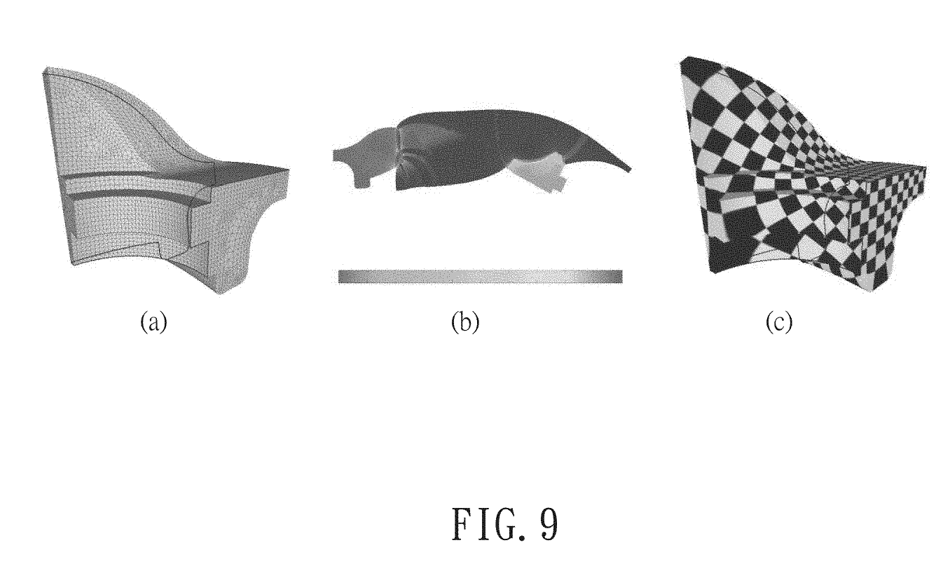

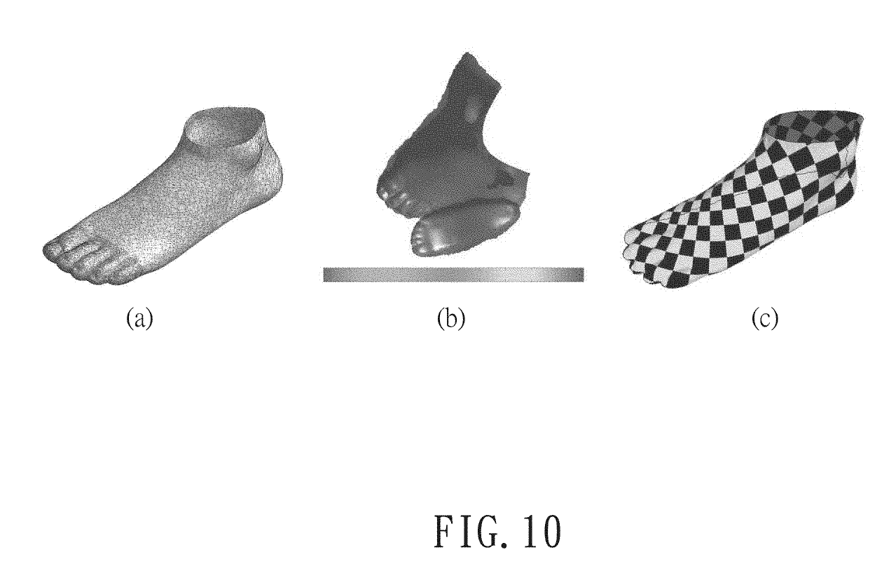

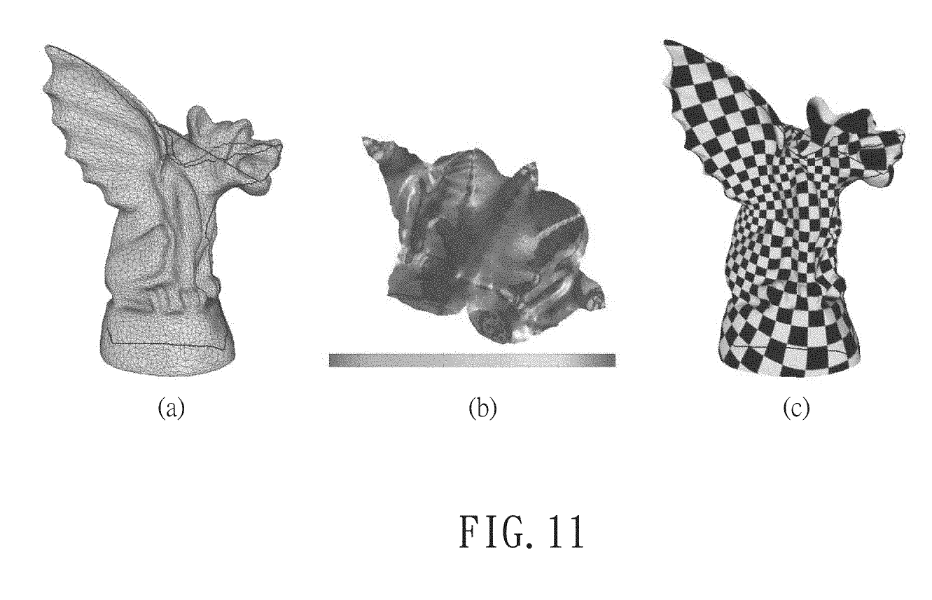

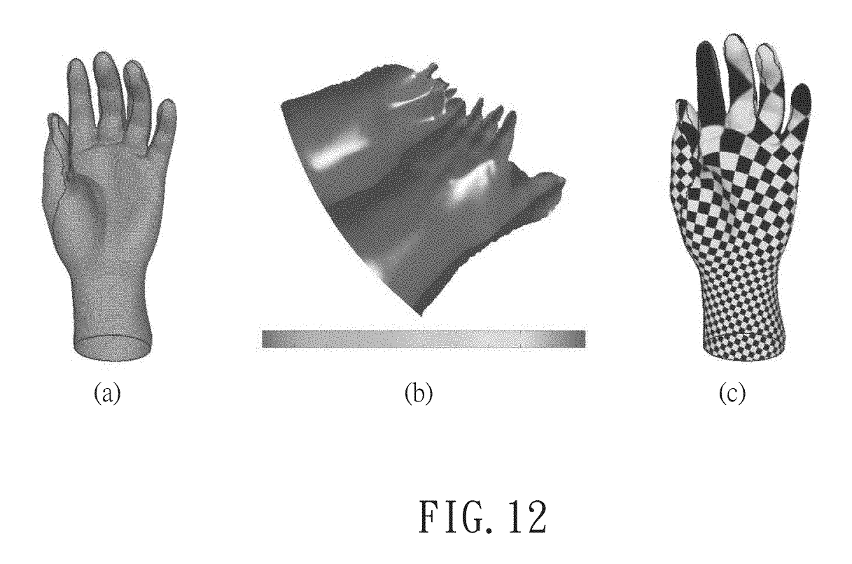

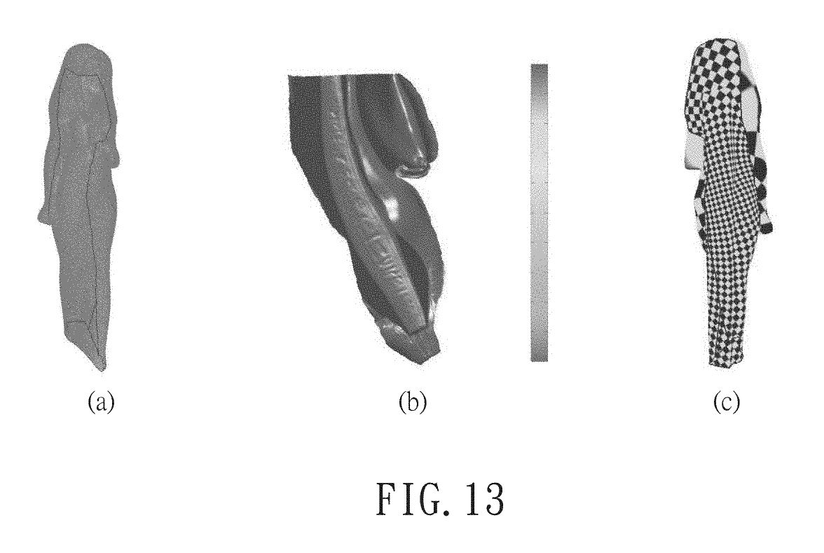

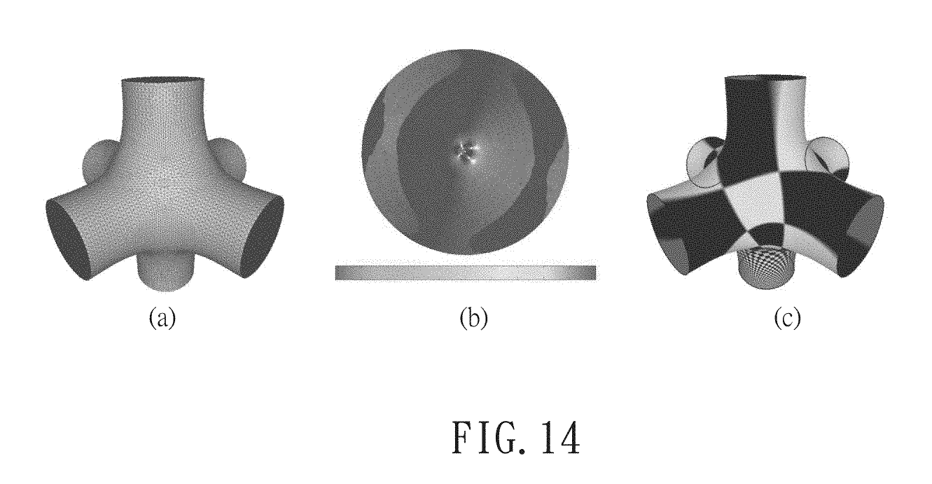

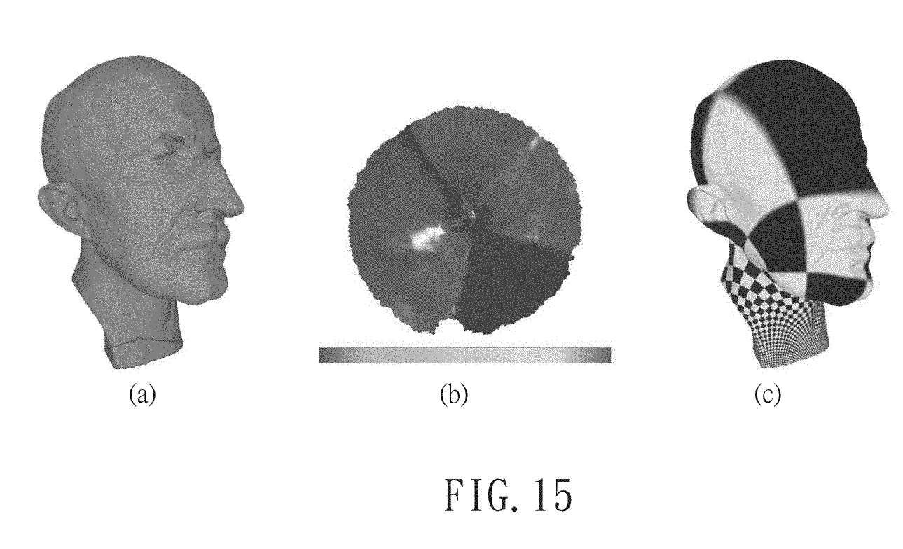

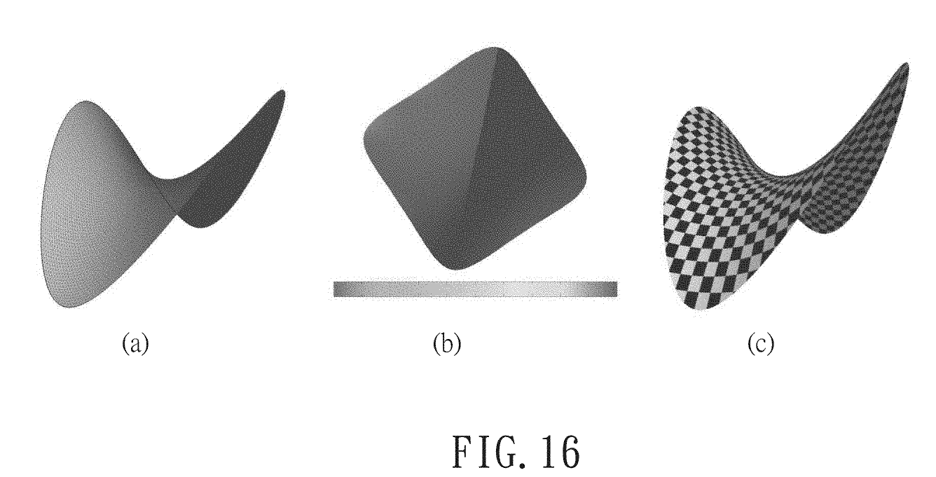

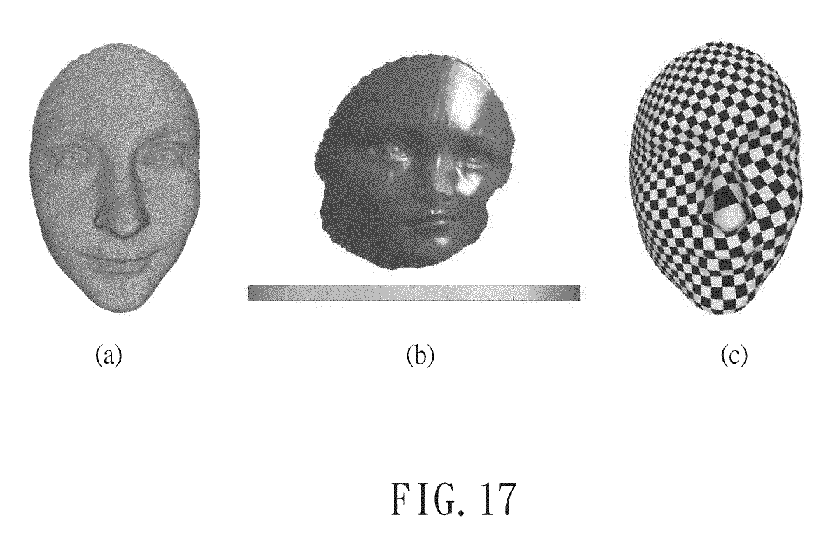

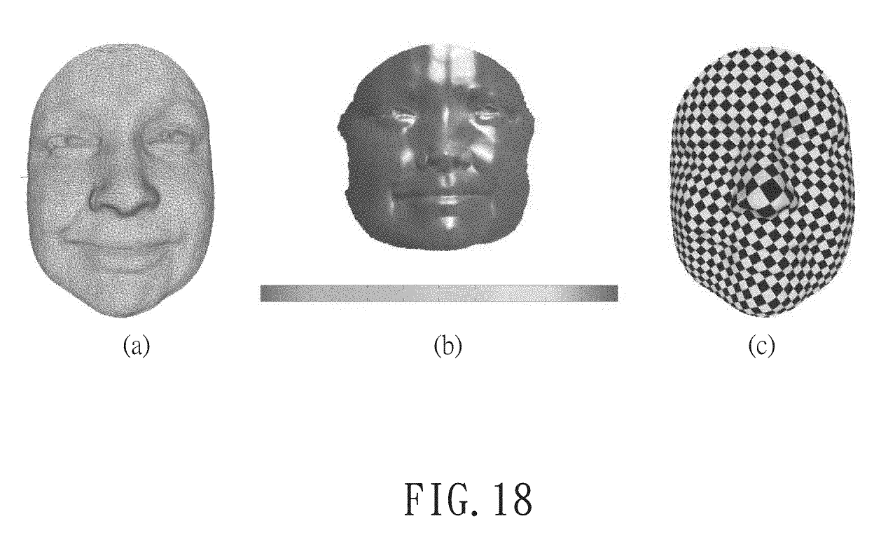

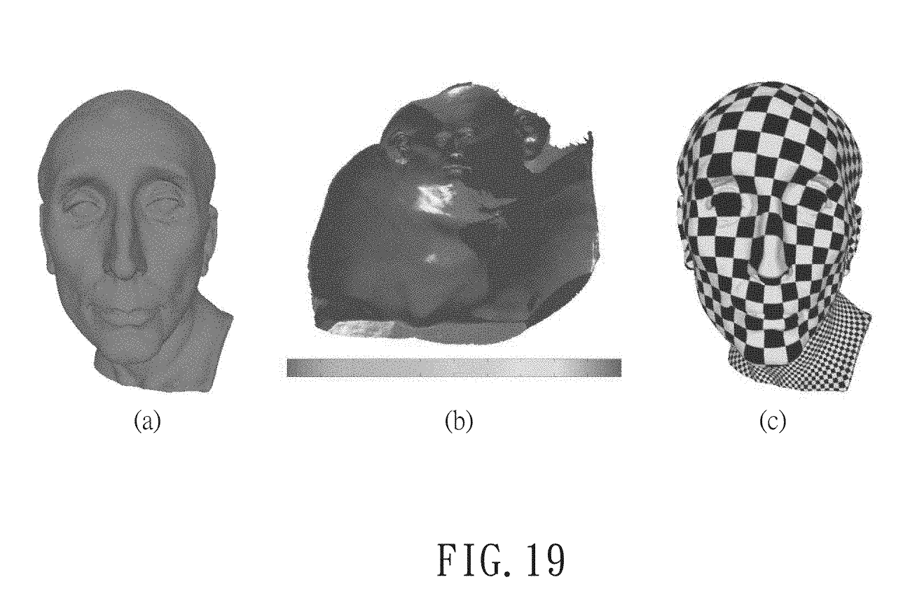

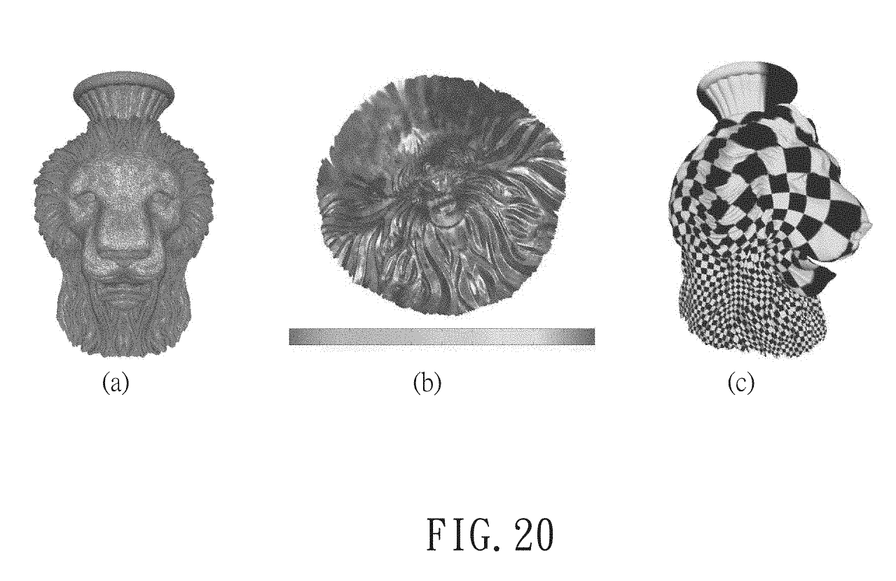

FIG. 2-20 are the parameterization results of several mesh models. In each figure, (a) is the original triangular mesh model, (b) shows the embedded parameter domain of SCP with color coded QC distortion, and (c) presents the SCP result with texture mapping.

Efficiency: From Table 1, it is observed that the SC_{RGEP} scheme is competitive with other methods only when the number of boundary vertex n_{b} is not too much. As nᵥ and n_{b} increase, especially for large n_{b}, SC_{RGEP} approach takes more and more time as well as memory to solve the matrix equation (3.11) and storage the computing results. Even in the example on Nicolo da Uzzano model, the SC_{RGEP} method was unable to solve the matrix equation (3.11) in 30 minutes and it eventually ran out of memory after 2331 seconds. In contrast, E_{MGEP}: has much better efficiency than the SC_{RGEP} approach. But, with the increasing numbers of nᵢ and n_{b}, is seen that, once again, E_{MGEP}: spends even two to four times more CPU time than those of these two Lanczos-type methods. The isotropic orthogonalization process is the significant difference between SHILA and the classical Lanczos method. First of all, the CPU time costs in Table 1 show that the isotropic orthogonalization process (in lines 17-19 of Algorithm 5.1) does not have a significant amount of time spent even when the iteration number of SL_{CDSEP} is equal to that of L_{CDSEP}. Moreover, according to the numbers of iteration, one can see that SHILA can absolutely remove the influence of duplicate eigenvalues, while the iteration numbers of L_{CDSEP} show that the classical Lanczos method can suffer the impact of double eigenvalues. The experiments reveal that the iteration numbers of SL_{CDSEP} are less than five to nine iterations of L_{CDSEP} procedure. This indicates that SHILA can efficiently improve the convergence rate and reduce the required CPU time.
Accuracy: From FIG. 1, it is found that E_{MGEP} lost the precision of the residuals ∥L_{C}f−λf∥₂, and the B-orthogonality (f′B [symbol] ₂=0). Since (3.7) is a singular GEP and almost any perturbation of a singular pencil will turn to a regular one (nearly singular), the eigs function can be used to compute the desired eigenpair of the nearly singular pencil corresponding to (3.7). Nevertheless, to compute the eigenpairs of a nearly singular pencil is very sensitive. As shown in FIG. 1 (ii), it is seen that the eigenvector f of (3.7), computed by eigs, cannot possess the B-orthogonality. Consequently, E_{MGEP} has only the accuracy of residuals between 10⁻⁶˜10⁻⁹ (see FIG. 1(i)). On the other hand, SL_{CDSEP} and L_{CDSEP} always have the same accuracy and are almost more accurate than S SC_{RGEP} (about 1 significant digit). Moreover, both SL_{CDSEP} and L_{CDSEP} have high precision on the requirements of the B-orthogonality.

Therefore SL_{CDSEP} has much better efficiency than SC_{RGEP} and better than L_{CDSEP} and E_{MGEP}. For accuracy, SL_{CDSEP} and L_{CDSEP} present high numerical accuracy. The accuracy of SL_{CDSEP} is much better than E_{MGEP} and is better than SC_{RGEP}. These data advocate the efficiency and accuracy of SL_{CDSEP}, a new derived CDSEP (4.9) together with the novel SHILA algorithm, as a fundamental tool for computing spectral conformal parameterizations.

In summary, spectral methods are not new in computer graphics and geometry processing, and have been developed to solve a diversity of problems. For an up-to-date survey on this topic, please refer to H Zhang, O. Van Kaick, and R. Dyer. Spectral mesh processing. Computer Graphics Forum, 29(6): 1865-1894, 2010. Since the potential quantities, such as eigenvalues and eigenvectors, of a spectral method are the primary factors to solve the concerning problem, how to accurately and efficiently dig out these eigeninformation is always an important issue.

Spectral conformal parameterization (SCP) is one of the various applications in spectral mesh processing. To compute a conformal mesh parameterization, SCP suggests to compute the eigenvector the GEP (generalized eigenvalue problem) (3.3) corresponding to its smallest positive eigenvalue. By inspecting the particular matrix structures of the par (L_{C}, B) in (3.3), appropriate nonequivalence deflation and null-space free compression techniques can be applied to transform this eigen-problem to the small-scaled CDSEP (4.9) with a symmetric positive semi-definite skew-Hamiltonian operator. An explicit representation for the coefficient matrices of the CDSEP (4.9) is derived and an implicit technique for practical implementation is proposed. Furthermore, a novel SHILA method for solving the CDSEP (4.9) has been developed.

Compared with the numerical implementations in previous research, the present method can accurately and robustly compute the conformal parameterizations.

What is claimed is:

1. A method for computing conformal parameterizations comprising the steps of:
computing a generalized eigenvalue problem (GEP) whose eigenvectors are corresponding to the smallest positive eigenvalues for providing a conformal parameterizations;
applying nonequivalence deflation and null-space free compression techniques to transform the GEP to a small-scaled compressed and deflated standard eigenvalue problem (CDSEP) with a symmetric positive semi-definite skew-Hamiltonian operator by inspecting a particular matrix structures of a pair; and
using a skew-Hamiltonian isotropic Lanczos algorithm (SHILA) for solving the CDSEP.

2. The method as claimed in claim 1, wherein the generalized eigenvalue problem (GEP) is defined by L_{C}f=λBf.

3. The method as claimed in claim 1, wherein the pair is defined by (L_{C}, B).
